(19) United States
(12) Patent Application Publication
(10) Pub. No.: US 2025/0230058 A1
(43) Pub. Date: Jul. 17, 2025

(54) METHOD FOR SYNTHESIZING NiO/ZnO NANOPARTICLES USING SOLUTION COMBUSTION AND A HIGH-CAPACITANCE SUPERCAPACITOR DEVICE THEREOF

(71) Applicant: PRINCESS NOURAH BINT ABDULRAHMAN UNIVERSITY, Riyadh (SA)

(72) Inventors: Mohd UBAIDULLAH, Riyadh (SA); Thamraa ALSHAHRANI, Riyadh (SA); V Jagadeesha ANGADI, Hubballi (IN); Anuj KUMAR, Mathura (IN); Saud ALAM, Delhi (IN); Mohd SHAHAZAD, Jaiharikhal (IN); Mohd. SHKIR, Abha (SA); Abdullah M. AL-ENIZI, Riyadh (IN); Mohammad YUSUF, Regina (CA); Dinesh KUMAR, Gandhinagar (IN); Yufeng ZHO, Shanghai (CN)

(73) Assignee: PRINCESS NOURAH BINT ABDULRAHMAN UNIVERSITY, Riyadh (SA)

(21) Appl. No.: 19/172,201

(22) Filed: Apr. 7, 2025

(51) Int. Cl. C01G 53/04; B82Y 40/00; C01G 9/02; H01G 11/46

(52) U.S. Cl. CPC C01G 53/04; C01G 9/02; H01G 11/46; B82Y 40/00; C01P 2004/64

(57) ABSTRACT

The present invention generally relates to a method for synthesizing NiO/ZnO nanoparticles using solution combustion synthesis. The method comprising: dissolving 10 grams of Zinc nitrate hexahydrate (Zn(NO₃)₂·6H₂O) and 10 grams of Nickel(II) nitrate hexahydrate (Ni(NO₃)₂·6H₂O) in 30 ml of double-distilled water to obtain a solution; adding at least one fuel selected from a group consisting of glucose, urea, and combinations thereof to the solution; stirring the solution for one hour to achieve homogeneity and transferring the homogeneous solution into a Pyrex dish; placing the dish inside a preheated muffle furnace at a temperature range of 440° C. to 460° C. and allowing the solution to boil, froth, and undergo exothermic combustion thereby retrieving the resulting fine nanoparticle powder upon completion of the reaction within 20 minutes; and cooling the synthesized powder to room temperature and grinding the powder to achieve a fine, uniform consistency, thereby forming NiO/ZnO nanoparticles.

### TECHNICAL FIELD

The present disclosure relates to the field of nanomaterials synthesis, particularly to a method for synthesizing metal oxide nanoparticles. More specifically, the invention relates to a solution combustion synthesis method for producing nickel oxide/zinc oxide (NiO/ZnO) nanoparticles and the application of these nanoparticles in high-capacitance supercapacitor devices.

### BACKGROUND

The increasing demand for efficient energy storage solutions has driven significant research into advanced devices like supercapacitors. Supercapacitors, also known as electrochemical capacitors, offer advantages such as high power density, long cycle life, and rapid charge-discharge capabilities, making them attractive for applications in portable electronics, electric vehicles, and renewable energy systems. Unlike conventional capacitors, supercapacitors store energy through faradaic redox reactions at the electrode-electrolyte interface, leading to higher energy densities. However, the performance of these devices is critically dependent on the electrode materials employed.

Transition metal oxides, particularly nickel oxide (NiO) and zinc oxide (ZnO), have been extensively investigated as electrode materials due to their pseudocapacitive properties arising from fast, reversible redox reactions. NiO is attractive due to its high theoretical capacitance, low cost, and environmental friendliness. However, its practical use is limited by poor electrical conductivity and relatively low surface area, hindering its energy storage capacity. Conversely, ZnO offers high electron mobility, a wide bandgap, and good chemical stability, but exhibits a lower capacitance compared to NiO, making it less suitable as a standalone supercapacitor material.

Recent research has explored combining NiO and ZnO into composite structures to leverage the synergistic effects of both materials and enhance overall electrochemical performance. These composites aim to capitalize on the complementary properties of NiO and ZnO, leading to improved ion diffusion, electron transport, and increased active sites for redox reactions. Such binary metal oxide composites have shown promise for high-performance supercapacitors, offering better charge storage capabilities.

Various synthesis methods have been employed to fabricate NiO/ZnO nanocomposites. Solution combustion synthesis stands out as a simple, cost-effective, and scalable approach for producing highly porous nanostructures with large surface areas. This method offers advantages in terms of controlling the morphology and particle size of the resulting nanomaterials. Furthermore, the resulting materials can exhibit multifunctional properties, such as enhanced catalytic activity, in addition to their supercapacitor performance. For example, the inclusion of ZnO in the NiO matrix has been shown to increase oxygen vacancies, which can further improve catalytic activity, particularly in applications like methane combustion. This multifunctionality makes these materials attractive for both energy storage and environmental remediation, addressing the growing need for materials that can serve multiple purposes.

In view of the foregoing discussion, it is portrayed that there is a need to have a method for synthesizing NiO/ZnO nanoparticles using solution combustion and a high-capacitance supercapacitor device.

### BRIEF SUMMARY

The present disclosure seeks to provide a synthesis process for NiO/ZnO nanocomposite using the solution combustion method. The unique synergy between ZnO's high electron mobility and NiO's superior redox activity leads to improved specific capacitance, cycling stability, and catalytic performance. This invention builds on those findings, synthesizing NiO/ZnO nanocomposites using a solution combustion method, which results in highly porous structures that exhibit better electrochemical and catalytic properties compared to previously reported materials. The present work also addresses some of the gaps in the existing literature by demonstrating the dual functionality of the composites for both supercapacitor and methane combustion applications.

In an embodiment, a method for synthesizing NiO/ZnO nanoparticles using solution combustion synthesis is disclosed. The method includes dissolving 10 grams of Zinc nitrate hexahydrate (Zn(NO₃)₂·6H₂O) and 10 grams of Nickel(II) nitrate hexahydrate (Ni(NO₃)₂·6H₂O) in 30 ml of double-distilled water to obtain a solution.

The method further includes adding at least one fuel selected from a group consisting of glucose, urea, and combinations thereof to the solution, wherein a molar ratio of solution to fuel is equimolar based on their respective oxidizing and reducing valencies.

The method further includes stirring the solution for one hour to achieve homogeneity and transferring the homogeneous solution into a Pyrex dish.

The method further includes placing the dish inside a preheated muffle furnace at a temperature range of 440° C. to 460° C. and allowing the solution to boil, froth, and undergo exothermic combustion thereby retrieving the resulting fine nanoparticle powder upon completion of the reaction within 20 minutes.

The method further includes cooling the synthesized powder to room temperature and grinding the powder to achieve a fine, uniform consistency, thereby forming NiO/ZnO nanoparticles.

In another embodiment, the fuel is a combination of 50% of glucose and 50% of urea.

In one embodiment, the stirring step is conducted using a magnetic stirrer operating at a speed between 200-500 rpm.

The method further comprising annealing the synthesized nanocomposite at a temperature range of 500-600° C. to enhance crystallinity and electrochemical properties.

The method further comprises fabricating a supercapacitor electrode, comprising mixing 90% of an active material selected from the group consisting of ZnO, NiO, and ZnO/NiO nanocomposite, with 5% of carbon black and 5% of polyvinylidene fluoride (PVDF) using a high-speed vortex mixer. Then, coating the mixture onto a nickel foam substrate. Thereafter, drying the coated nickel foam substrate under vacuum overnight at a temperature of approximately 50° C.

Yet, in another embodiment, the high-speed vortex mixer operates at approximately 600 rpm, wherein the coated nickel foam substrate is dried for a duration of at least 8 hours.

The method further comprises assembling a three-electrode system comprising the fabricated electrode as a working electrode, a calomel reference electrode, and a platinum wire counter electrode in a 3 M KOH aqueous electrolyte.

In one of the above embodiments, ZnO, NiO, and ZnO/NiO nanocomposite is preferably in mass proportions of 0.0106 g, 0.0109 g, and 0.0118 g, respectively.

In a further embodiment, a high-capacitance supercapacitor device is disclosed. The device includes a working electrode comprising a NiO/ZnO nanocomposite.

The device further includes a platinum wire counter electrode.

The device further includes a calomel reference electrode.

The device further includes an electrolyte container containing a 3 M KOH aqueous electrolyte, wherein the NiO/ZnO nanocomposite is synthesized by a method comprising: dissolving 10 grams of Zinc nitrate hexahydrate (Zn(NO₃)₂·6H₂O) and 10 grams of Nickel(II) nitrate hexahydrate (Ni(NO₃)₂·6H₂O) in 30 ml of double-distilled water to obtain a solution, adding at least one fuel selected from a group consisting of glucose, urea, and combinations thereof to the solution, stirring the solution for one hour to achieve homogeneity and transferring the homogeneous solution into a Pyrex dish, placing the dish inside a preheated muffle furnace at a temperature range of 440° C. to 460° C. and allowing the solution to boil, froth, and undergo exothermic combustion thereby retrieving the resulting fine nanoparticle powder upon completion of the reaction within 20 minutes, and cooling the synthesized powder to room temperature and grinding the powder to achieve a fine, uniform consistency, thereby forming NiO/ZnO nanoparticles, and wherein the supercapacitor exhibits a specific capacitance of at least 561.75 F/g and retains at least 94% of its initial capacitance after 5000 cycles.

Yet, in a further embodiment, the NiO/ZnO nanocomposite is incorporated with carbon black and a binder to form a paste, which is coated onto a nickel foam substrate to form the working electrode.

An object of the present disclosure is to synthesize a ZnO/NiO composite material that exhibits a significantly higher specific capacitance compared to its individual components (NiO and ZnO) and surpasses the performance of many other reported binary metal oxide composites. This enhanced capacitance aims to approach or exceed the performance of even the best-performing materials, demonstrating a substantial improvement in charge storage capacity.

Another object of the present disclosure is to produce a ZnO/NiO composite with the lowest possible charge transfer resistance. This reduction in resistance facilitates faster ion and electron transport within the electrode material, leading to improved power density and rate capability of the supercapacitor device. The formation of a p-n heterojunction between NiO and ZnO is specifically targeted as a means to enhance conductivity and minimize charge transfer resistance.

Another object of the present disclosure is to utilize the unique properties of the p-n heterojunction formed between the p-type NiO and n-type ZnO. This heterojunction is intended to improve electron mobility and charge transfer, resulting in a significant boost in both capacitance and conductivity compared to materials without such a junction. This targeted structural feature aims to provide a performance advantage over other composite materials.

Yet another object of the present invention is to deliver an expeditious and cost-effective ZnO/NiO composite electrode that demonstrates excellent cyclic stability and high capacitance retention over extended charge-discharge cycles. This improved stability ensures the long-term performance and reliability of the supercapacitor device, making it suitable for practical applications.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF FIGURES

These and other features, aspects, and advantages of the present disclosure will become better understood when the following detailed description is read concerning the accompanying drawings in which like characters represent like parts throughout the drawings, wherein:

FIG. 1 illustrates a block diagram of a high-capacitance supercapacitor device in accordance with an embodiment of the present disclosure;

FIG. 2 illustrates a flow chart of a method for synthesizing NiO/ZnO nanoparticles using solution combustion synthesis in accordance with an embodiment of the present disclosure;

FIG. 3 illustrates a XRD pattern of ZnO and NiO and their composite;

FIG. 4 illustrates a Light-off curves of methane combustion on Zno,Nio and ZnO/NiO composites;

FIG. 5 illustrates Relationship between temperature and reaction rate for methane combustion (calculated by the surface area reaction rate);

FIG. 6(a) illustrates Cyclic voltammetry study of ZnO at the different scan rates from 10 to 100 mV S⁻¹;

FIG. 6(b) illustrates Cyclic voltammetry study of NiO at the different scan rates from 10 to 100 mV S⁻¹;

FIG. 6(c) illustrates Cyclic voltammetry study of ZnO/NiO Composite at the different scan rates from 10 to 100 mV S⁻¹;

FIG. 7(a) illustrates FRA impedance analysis of pure NiO;

FIG. 7(b) illustrates FRA impedance analysis of ZnO;

FIG. 7(c) illustrates FRA impedance analysis of ZnO/NiO Composite;

FIG. 8 illustrates Specific capacitance (Csp) of pure ZnO, NiO and ZnO/NiO composite Vs Current density (Ag⁻¹);

FIG. 9 illustrates a bar graph comparing specific capacitance;

FIG. 10 illustrates a Nyquist plot comparing charge transfer resistance (R_ct);

FIG. 11 illustrates capacitive retention over cycles;

FIG. 12 illustrates a Table depicting key comparisons & observations; and

FIG. 13 illustrates a Table depicting a comparison with existing technology.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

To promote an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail concerning the accompanying drawings.

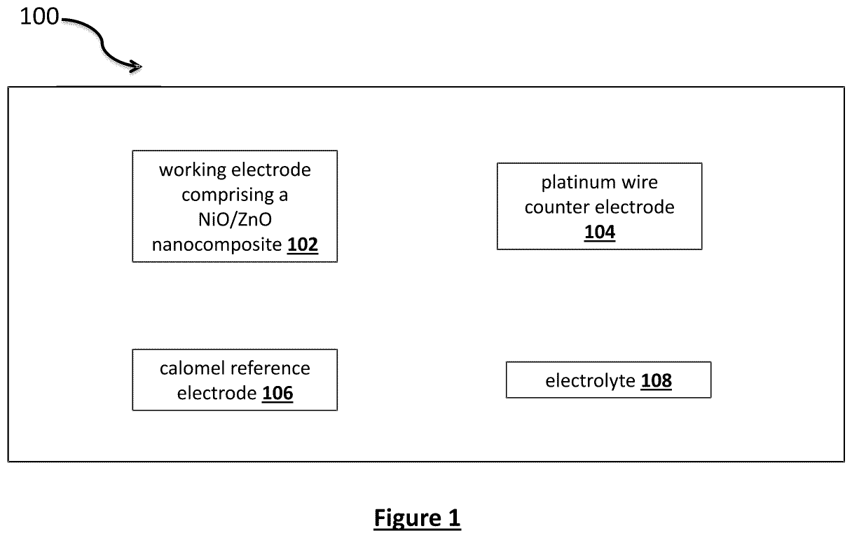

Referring to FIG. 1, a block diagram of a high-capacitance supercapacitor device is illustrated in accordance with an embodiment of the present disclosure. The device (100) includes a working electrode (102) comprising a NiO/ZnO nanocomposite.

In an embodiment, a platinum wire counter electrode (104).

In an embodiment, a calomel reference electrode (106).

In an embodiment, an electrolyte (108) container containing a 3 M KOH aqueous electrolyte, wherein the NiO/ZnO nanocomposite is synthesized by a method comprising: dissolving 10 grams of Zinc nitrate hexahydrate (Zn(NO₃)₂·6H₂O) and 10 grams of Nickel(II) nitrate hexahydrate (Ni(NO₃)₂·6H₂O) in 30 ml of double-distilled water to obtain a solution, adding at least one fuel selected from a group consisting of glucose, urea, and combinations thereof to the solution, stirring the solution for one hour to achieve homogeneity and transferring the homogeneous solution into a Pyrex dish, placing the dish inside a preheated muffle furnace at a temperature range of 440° C. to 460° C. and allowing the solution to boil, froth, and undergo exothermic combustion thereby retrieving the resulting fine nanoparticle powder upon completion of the reaction within 20 minutes, and cooling the synthesized powder to room temperature and grinding the powder to achieve a fine, uniform consistency, thereby forming NiO/ZnO nanoparticles, and wherein the supercapacitor exhibits a specific capacitance of at least 561.75 F/g and retains at least 94% of its initial capacitance after 5000 cycles.

Yet, in a further embodiment, the NiO/ZnO nanocomposite is incorporated with carbon black and a binder to form a paste, which is coated onto a nickel foam substrate to form the working electrode.

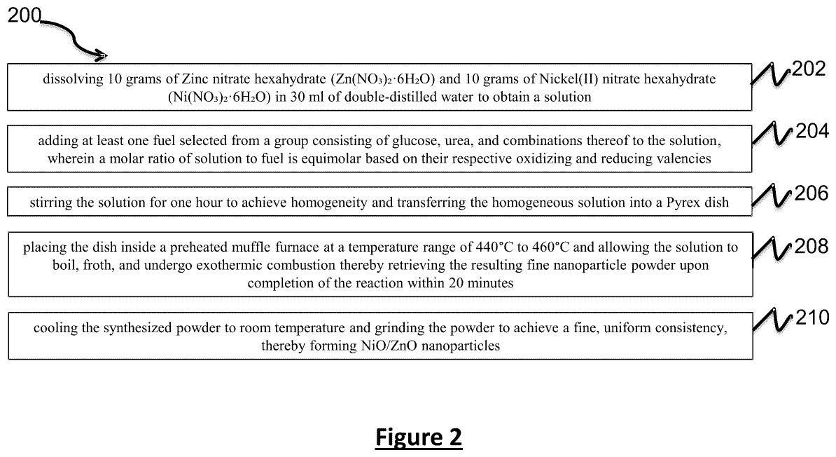

FIG. 2 illustrates a flow chart of a method for synthesizing NiO/ZnO nanoparticles using solution combustion synthesis in accordance with an embodiment of the present disclosure. At step (202), method (200) includes dissolving 10 grams of Zinc nitrate hexahydrate (Zn(NO₃)₂·6H₂O) and 10 grams of Nickel(II) nitrate hexahydrate (Ni(NO₃)₂·6H₂O) in 30 ml of double-distilled water to obtain a solution.

At step (204), method (200) includes adding at least one fuel selected from a group consisting of glucose, urea, and combinations thereof to the solution, wherein a molar ratio of solution to fuel is equimolar based on their respective oxidizing and reducing valencies.

At step (206), method (200) includes stirring the solution for one hour to achieve homogeneity and transferring the homogeneous solution into a Pyrex dish.

At step (208), method (200) includes placing the dish inside a preheated muffle furnace at a temperature range of 440° C. to 460° C. and allowing the solution to boil, froth, and undergo exothermic combustion thereby retrieving the resulting fine nanoparticle powder upon completion of the reaction within 20 minutes.

At step (210), method (200) includes cooling the synthesized powder to room temperature and grinding the powder to achieve a fine, uniform consistency, thereby forming NiO/ZnO nanoparticles.

In another embodiment, the fuel is a combination of 50% of glucose and 50% of urea.

In one embodiment, the stirring step is conducted using a magnetic stirrer operating at a speed between 200-500 rpm.

The method further comprising annealing the synthesized nanocomposite at a temperature range of 500-600° C. to enhance crystallinity and electrochemical properties.

The method further comprises fabricating a supercapacitor electrode, comprising mixing 90% of an active material selected from the group consisting of ZnO, NiO, and ZnO/NiO nanocomposite, with 5% of carbon black and 5% of polyvinylidene fluoride (PVDF) using a high-speed vortex mixer. Then, coating the mixture onto a nickel foam substrate. Thereafter, drying the coated nickel foam substrate under vacuum overnight at a temperature of approximately 50° C.

Yet, in another embodiment, the high-speed vortex mixer operates at approximately 600 rpm, wherein the coated nickel foam substrate is dried for a duration of at least 8 hours.

The method further comprises assembling a three-electrode system comprising the fabricated electrode as a working electrode, a calomel reference electrode, and a platinum wire counter electrode in a 3 M KOH aqueous electrolyte.

In one of the above embodiments, ZnO, NiO, and ZnO/NiO nanocomposite is preferably in mass proportions of 0.0106 g, 0.0109 g, and 0.0118 g, respectively.

### Synthesis

NiO/ZnO nanoparticles were synthesized using the solution combustion synthesis method with glucose and urea as fuels. A constant molar concentration was achieved by dissolving 10 grams of Zn(NO₃)₃·6H₂O in 30 ml of double-distilled water. Stoichiometric amounts of urea, glucose, or a combination of both were added to this solution to serve as the fuel. The ratio of oxidizers to fuel was equimolar, determined based on the oxidizing and reducing valencies of the compounds involved. The use of a fuel mixture was intended to enhance exothermicity and ensure complete reaction, as explained by the chemical reactions occurring during the process. The metal nitrates and fuels were dissolved using a magnetic stirrer for one hour until a homogeneous solution formed. This solution was then transferred to a Pyrex dish and placed in a preheated muffle furnace at 440 to 460 degrees Celsius. The solution initially boiled and then frothed, resulting in a fine powder. The combustion process was completed within 20 minutes.

### Characterization Techniques

X-ray Powder Diffraction (XRD): Equipment: Bruker D8 Advance diffractometer with Cu Kα radiation. Super capacitor study:—The mass of the active materials, ZnO (0.0106 g), NiO (0.0109 g), and ZnO/NiO nanocomposite (0.0118 g), resulting in 90% of the samples, along with carbon black (5%), polyvinylidene fluoride (PVDF) (5%), were thoroughly mixed using a high-speed Vortex mixer at 600 rpm before getting coated on dry nickel foam (1 cm×1 cm). This was done in order to measure the electrochemical performance. The coated nickel foam underwent an overnight vacuum finish at 50° C. in a laboratory oven. Using an analytical balance, the electrode's weight was carefully determined before and after fabrication. Three electrodes were used in the electrochemical evaluations. All the sample-coated electrodes were used as a working electrode, calomel reference electrode and platinum wire counter electrode, in a 3 M KOH aqueous electrolyte. All the electrochemical characterization Cyclic voltammetry, FRA impedance was done by using a multichannel potentiostat/galvanostat (AUTOLAB M204.S, from Netherlands). The working voltage window of 0 to −1 V was used to record the results of the 3-electrode system.

In an embodiment, the step of dissolving 10 grams of Zinc nitrate hexahydrate and 10 grams of Nickel(II) nitrate hexahydrate in 30 ml of double-distilled water further comprises sequential addition of the Zinc nitrate hexahydrate followed by the Nickel(II) nitrate hexahydrate under continuous stirring, wherein the sequential addition promotes differential solvation kinetics between Zn²⁺ and Ni²⁺ ions, thereby reducing the risk of uncontrolled ionic aggregation, and wherein the complete dissolution is confirmed by achieving a visually clear and color-uniform solution before proceeding to the fuel addition step, and wherein the step of adding at least one fuel to the aqueous solution comprising the dissolved metal nitrates comprises preparing a premixed fuel blend of glucose and urea in a 1:1 molar ratio, wherein the fuel blend is pre-dissolved in a separate aliquot of double-distilled water at 60° C. to ensure complete disintegration of carbohydrate crystals and homogeneous molecular dispersion, and wherein the fuel solution is added dropwise to the nitrate solution under constant magnetic stirring to prevent local hot spots and to facilitate molecular-level mixing of oxidizing and reducing species.

In one exemplary embodiment of the invention, the method for synthesizing NiO/ZnO nanoparticles via solution combustion synthesis incorporates a critically optimized dissolution and fuel integration protocol to ensure molecular-level homogeneity and prevent premature reactions. Specifically, the step of dissolving 10 grams of Zinc nitrate hexahydrate and 10 grams of Nickel(II) nitrate hexahydrate into 30 ml of double-distilled water is executed through a sequential addition process under constant magnetic stirring. The zinc nitrate is introduced first into the aqueous medium, followed by the addition of nickel nitrate only after the former is fully solubilized. This sequence is not arbitrary but rooted in the distinct solvation energetics of the two metal cations. Zn²⁺ ions, having a slightly smaller hydrated radius and faster dissociation kinetics, readily solvate in water and form stable aqua complexes. By dissolving Zn²⁺ first, the solution environment becomes partially conditioned, allowing the slower-solvating Ni²⁺ ions to integrate without inducing localized supersaturation or precipitation events. This approach mitigates the formation of transient ionic clusters or hydrolytic species that could adversely affect the morphology and phase purity of the final product. The solution is visually monitored until a fully transparent, uniformly colored mixture is achieved, which serves as a qualitative indicator of complete dissolution and homogeneous ionic dispersion.

Following metal salt dissolution, a pre-formulated fuel mixture comprising glucose and urea in a 1:1 molar ratio is prepared in a separate container. The blend is dissolved in double-distilled water maintained at 60° C., a temperature selected based on the thermal softening point of glucose and the hydrogen-bonding behavior of urea. At this elevated temperature, the carbohydrate crystals disintegrate more efficiently, leading to a clear solution in which glucose and urea molecules are fully solvated and evenly dispersed. The resulting fuel solution—now free from any insoluble residue—is gradually introduced dropwise into the nitrate solution under continuous magnetic stirring. The dropwise addition plays a vital role in maintaining thermal and chemical uniformity, as it prevents the sudden creation of local hot spots or exothermic microzones that might lead to premature redox interactions. The magnetic stirring during this process facilitates molecular-level intermixing of the oxidizing metal nitrate ions and the reducing fuel species, establishing a stoichiometrically balanced precursor matrix. This homogeneous mixing at the molecular level is critical to achieving uniform combustion propagation, nano-scaling of the resultant oxides, and controlled morphology in the final nanoparticle product. The described sequence and procedural controls form the foundation for a highly reproducible and tunable synthesis process, allowing for scalable production of electrochemically active NiO/ZnO nanocomposites with minimal agglomeration and enhanced surface properties.

In an embodiment, the stirring step is conducted using a magnetic stirrer operating at a speed between 200-500 rpm, and wherein the magnetic stirring of the combined nitrate-fuel solution at 200-500 rpm for one hour is carried out at a controlled solution temperature between 50° C. and 60° C., wherein the temperature is maintained using a thermostatically controlled hotplate to enhance solvation dynamics without initiating premature thermal decomposition, and wherein the pH of the mixture during stirring is monitored and adjusted to remain between 6.0 and 7.0 using dilute nitric acid to ensure metal ion stability and suppression of undesired hydrolytic precipitation prior to combustion.

In a further embodiment of the invention, the stirring step is meticulously executed using a magnetic stirrer operating within a rotational speed range of 200 to 500 revolutions per minute (rpm), optimized for sustaining homogeneity without introducing turbulent vortex formation that might lead to localized thermal imbalances. The combined nitrate-fuel solution, composed of dissolved zinc and nickel nitrates along with a premixed glucose-urea fuel blend, is stirred continuously at this speed for a duration of one hour. This extended stirring period is crucial to facilitate complete molecular dispersion and to allow adequate time for ionic equilibration among the various oxidizing and reducing species present in the solution. During this process, the temperature of the solution is rigorously maintained between 50° C. and 60° C. using a thermostatically controlled hotplate, which provides fine thermal regulation to prevent unintentional premature decomposition or volatilization of the reactants.

The selected temperature range enhances solvation kinetics, particularly for high-energy fuel components such as urea and glucose, while simultaneously maintaining the structural integrity of the metal-ligand complexes formed in solution. It also supports stable hydrogen bonding interactions that may occur between the fuel molecules and nitrate ions, promoting a uniformly reactive precursor matrix. Importantly, the solution pH is continuously monitored throughout the stirring phase, with adjustments made using dilute nitric acid to maintain the pH within the range of 6.0 to 7.0. This pH window is strategically chosen to stabilize the dissolved Zn²⁺ and Ni²⁺ ions in their ionic form while minimizing the risk of hydrolytic precipitation into insoluble hydroxide species such as Zn(OH)₂ or Ni(OH)₂, which are known to form at alkaline conditions.

Maintaining near-neutral pH ensures that the solution retains its compositional fidelity and ionic activity, which are essential for ensuring an effective redox balance during the forthcoming combustion phase. For example, if the pH were to rise above 7.0, the probability of forming colloidal or particulate hydroxides would increase, leading to inhomogeneous combustion and large particle agglomerates in the final product. Conversely, excessively acidic conditions may protonate the fuel species, altering their reductive efficiency and compromising the combustion exothermicity. Therefore, the combined control of rpm, temperature, and pH during this stirring phase directly supports the generation of a highly stable, uniform, and stoichiometrically optimized precursor solution—an essential prerequisite for achieving high surface area, phase-pure NiO/ZnO nanomaterials with desirable electrochemical characteristics.

In an embodiment, the step of placing the homogeneous solution into the muffle furnace at a temperature range of 440° C. to 460° C. further comprises holding the solution undisturbed during combustion for a duration not exceeding 20 minutes, wherein the combustion proceeds through observable phases including initial solvent evaporation, frothing due to gas evolution, onset of ignition, and spontaneous flame propagation, and wherein the transition from frothing to ignition occurs within 6 to 8 minutes from furnace insertion, indicating sufficient accumulation of reactive intermediates for self-sustaining combustion without external flame initiation.

In one particularly critical embodiment of the disclosed invention, the homogeneous precursor solution—comprising thoroughly mixed metal nitrates and the premixed glucose-urea fuel blend—is transferred into a high-temperature muffle furnace preheated to a controlled temperature range of 440° C. to 460° C. This narrow temperature window is strategically selected based on empirical thermal analysis data, such as Differential Scanning Calorimetry (DSC) and Thermogravimetric Analysis (TGA), which confirm the onset of combustion reactions and maximum exothermic activity for the precursor constituents. Once placed inside the furnace, the solution is left completely undisturbed throughout the combustion event, allowing the thermally driven redox reaction to proceed naturally without the need for external ignition sources such as a pilot flame or hot wire. This hands-off protocol ensures uniform energy distribution and minimizes disruptive convective air currents that could otherwise skew the reaction front propagation.

The combustion process follows a sequence of visually distinguishable and chemically significant phases. Initially, solvent evaporation dominates as water molecules escape from the precursor matrix, leading to a visible decrease in liquid volume. This is followed by the frothing phase, where rapid evolution of gaseous byproducts—mainly CO₂, NH₃, and water vapor—causes vigorous bubbling. The generation of these gases results from the decomposition of fuel molecules (glucose and urea) and the concurrent reduction of nitrate ions. This frothing phase serves as an essential indicator of the buildup of reactive intermediates. Subsequently, within 6 to 8 minutes of furnace insertion, ignition spontaneously initiates without any external trigger. This self-ignition is facilitated by the accumulated thermal energy and the exothermic interaction between the oxidizers and reducers within the gel-like mass formed during the frothing stage.

At this point, a spontaneous combustion wave propagates through the mixture in the form of a visible flame front, consuming the precursors and leaving behind a voluminous, foamy solid residue. The flame propagation is typically rapid and self-sustaining, owing to the optimized stoichiometry and uniform distribution of redox-active species. The entire combustion process is allowed to continue for no more than 20 minutes to ensure complete conversion of reactants while preventing overheating that might lead to nanoparticle sintering or collapse of the porous architecture. The resultant product is a lightweight, foamy mass of NiO/ZnO nanocomposite that retains structural features imparted during combustion, such as high porosity and nanoscale texture. The sequence, timing, and temperature control of this embodiment are critical to achieving phase purity, controlled crystallite size, and enhanced electrochemical properties in the synthesized nanomaterials.

In an embodiment, the annealing of the synthesized NiO/ZnO nanoparticle powder is performed under an inert argon atmosphere at a temperature of 550° C. for 3 hours, wherein the annealing temperature is increased at a ramp rate of 2° C. per minute to the target temperature to avoid particle sintering, and wherein the annealed powder is cooled to room temperature inside the closed furnace chamber to prevent thermal shock and moisture adsorption which may compromise the oxide phase integrity,
wherein the step of mixing 90% of an active material with 5% carbon black and 5% PVDF is preceded by dispersion of the active material in N-methyl-2-pyrrolidone (NMP) using ultrasonication for 15 minutes, wherein the ultrasonication is carried out at 60% amplitude using a probe sonicator to break apart agglomerated nanoparticles and uniformly suspend them, and wherein the subsequent mixing using a high-speed vortex mixer at approximately 600 rpm for 30 minutes results in a viscous, homogeneously distributed electrode slurry suitable for uniform deposition onto the nickel foam substrate; and
wherein the annealing temperature is selected based on preliminary thermogravimetric and differential scanning calorimetry analysis of the as-synthesized nanopowder, wherein the temperature corresponding to the complete crystallization and burnout of organic residues is identified from exothermic peaks in the thermal profile, and wherein this data is used to fix the optimal annealing temperature within the specified range of 500-600° C. to improve oxide phase purity and suppress undesired secondary phases.

In an advanced embodiment of the invention, the post-synthesis annealing of the NiO/ZnO nanoparticle powder is performed under a rigorously controlled inert environment to enhance crystallinity, phase purity, and thermal stability while minimizing unwanted grain growth or particle sintering. Specifically, the foamy combustion-derived powder is placed in a tubular or box-type furnace purged with high-purity argon gas, and the annealing temperature is raised incrementally to 550° C. at a precise ramp rate of 2° C. per minute. This gradual heating protocol is critical to controlling nucleation and grain growth kinetics during phase transformation, particularly in nanoparticulate systems where abrupt thermal exposure can lead to particle coalescence and loss of high surface area. The 3-hour dwell time at 550° C. ensures thorough decomposition of any residual organic matter or incomplete combustion by-products, while also promoting the crystallization of distinct NiO and ZnO oxide phases with defined lattice parameters.

Upon completion of the annealing process, the furnace is allowed to cool passively to room temperature with the chamber sealed, maintaining the inert argon atmosphere. This closed-system cooling is specifically designed to avoid rapid thermal gradients that can induce microcracks (thermal shock) and to eliminate exposure to atmospheric moisture, which might be readily adsorbed by the high-surface-area powder and compromise oxide stoichiometry or surface functionality. The choice of 550° C. as the annealing temperature is not arbitrary but rather informed by detailed thermal characterization using thermogravimetric analysis (TGA) and differential scanning calorimetry (DSC). These thermal profiles typically show distinct exothermic peaks corresponding to organic decomposition and oxide crystallization events. By selecting a temperature slightly above the last exothermic event but below sintering thresholds, the process ensures maximal crystallinity and minimal formation of undesired secondary or mixed phases.

Following annealing, the electrode slurry is formulated using a standard ratio of 90% active NiO/ZnO material, 5% carbon black as the conductive additive, and 5% polyvinylidene fluoride (PVDF) as the binder. Prior to mixing, the annealed nanopowder is dispersed in N-methyl-2-pyrrolidone (NMP), a high-boiling polar aprotic solvent, through ultrasonication for 15 minutes using a probe sonicator operated at 60% amplitude. This ultrasonication step is essential for deagglomerating the nanoparticles, as it generates cavitation forces that break apart weakly bound particle clusters, thus ensuring a uniform colloidal suspension. The ultrasonicated dispersion is then subjected to high-speed vortex mixing at approximately 600 rpm for 30 minutes to integrate carbon black and PVDF uniformly, resulting in a viscous, stable, and homogeneously mixed electrode slurry.

This slurry is characterized by suitable rheological properties for direct deposition onto a three-dimensional conductive substrate such as nickel foam. The even distribution of active particles and conductive pathways within the slurry enhances both mechanical adhesion and electron transport during electrochemical cycling. The combined effect of the controlled annealing and slurry preparation protocols ensures the final electrode exhibits superior phase stability, conductivity, and electrochemical performance, making it suitable for applications such as supercapacitors, batteries, or electrocatalysis.

In an embodiment, the combustion step further comprises real-time monitoring of the reaction vessel through a quartz observation port in the furnace, wherein visible light emissions corresponding to distinct combustion phases are used to identify ignition onset and flame front progression, and wherein the self-sustaining reaction is allowed to proceed without external intervention to completion, as indicated by cessation of luminescence and the emergence of a solid foamy residue with distinct color transition from brown to light grey, and wherein after combustion and before grinding, the intermediate foamy powder is subjected to gentle crushing using a non-metallic spatula under a fume hood, wherein the goal is to break down fragile macrostructures without generating static charges or introducing metallic contamination, and wherein the intermediate material is then transferred to an agate mortar for manual grinding until a particle size distribution below 100 microns is visually confirmed via sieving, and wherein the final ground powder is washed with ethanol and deionized water in a 1:1 ratio and dried at 80° C. for 4 hours in a vacuum oven, wherein this washing step is intended to remove residual carbonaceous by-products or unreacted organic fuel remnants, and wherein the success of washing is confirmed by observing the disappearance of C-H stretching bands in the FTIR spectrum of the dried powder.

In a further embodiment of the invention, the combustion synthesis process is enhanced with real-time visual diagnostics by utilizing a quartz observation port integrated into the high-temperature muffle furnace. This transparent, thermally stable window allows continuous monitoring of the reaction vessel during combustion without disturbing the internal thermal environment. The combustion reaction is tracked based on visible light emissions, which act as qualitative indicators of specific reaction phases. Initially, the solution displays minimal luminescence, corresponding to the solvent evaporation stage. As the temperature increases and the redox reactions between metal nitrates and the glucose-urea fuel begin, frothing and light gas evolution become evident. This is followed by the spontaneous ignition phase, marked by the appearance of intense light due to flame front propagation. The ignition typically travels across the surface and through the depth of the precursor mass, resulting in rapid, self-sustaining combustion. The reaction is allowed to proceed to completion without external intervention, with the endpoint characterized by a visible cessation of luminescence and a clear color change in the solid product—from brown to light grey—indicative of oxidation completion and transition to the final oxide form.

Upon cooling, the as-synthesized foamy intermediate, while structurally porous and lightweight, is mechanically fragile. To preserve the nano-architectural features while reducing particle size, the material is carefully crushed using a non-metallic spatula under a fume hood. This step avoids the risk of generating static electricity or introducing metallic contaminants that could alter the electronic or catalytic properties of the final NiO/ZnO nanocomposite. The gently crushed powder is then transferred to an agate mortar and manually ground to further reduce its particle size. The endpoint of this grinding step is a visually verified particle size below 100 microns, typically confirmed through manual sieving.

Following grinding, the powder undergoes a purification process to remove residual carbonaceous matter or any unreacted organics from the combustion phase. This is done through a washing step involving ethanol and deionized water in a 1:1 volumetric ratio. The choice of ethanol is critical due to its ability to dissolve organic residues while being miscible with water, which facilitates uniform wetting and cleaning of the powder surface. The washing is performed with gentle agitation to preserve nanoparticle integrity. The washed material is subsequently dried at 80° C. for 4 hours in a vacuum oven to remove any adsorbed solvents without exposing the nanoparticles to oxidative or thermal stress.

The success of the washing process is validated through Fourier-transform infrared (FTIR) spectroscopy. Specifically, the absence of C-H stretching vibrations (typically appearing in the 2800-3000 cm¹ region) in the FTIR spectrum of the dried powder confirms the effective removal of residual fuel components or carbon-based intermediates. This sequence of combustion monitoring, post-combustion handling, and chemical purification ensures that the final NiO/ZnO nanopowder exhibits high purity, minimal contamination, and optimized morphology-making it ideally suited for applications demanding high surface area and chemical stability, such as in electrochemical energy storage or catalysis.

In an embodiment, the mixture comprising 90% of ZnO/NiO nanocomposite, 5% carbon black, and 5% PVDF is prepared by first dissolving PVDF in NMP at 80° C. under magnetic stirring for 1 hour to form a uniform polymer solution, wherein the active material and carbon black are incrementally added to the polymer solution under vortex agitation to prevent phase separation, and wherein the final slurry viscosity is maintained between 500-700 cP to enable consistent electrode coating thickness on the nickel foam substrate, and wherein after coating the slurry onto the nickel foam substrate, the coated substrate is allowed to air-dry for 2 hours before vacuum drying at approximately 50° C., wherein this two-stage drying facilitates slow solvent evaporation to prevent crack formation in the electrode film, and wherein the vacuum drying is conducted in a humidity-controlled chamber (RH<10%) to avoid moisture absorption by the polymer binder, thereby preserving interparticle adhesion.

In an embodiment of the invention focusing on electrode fabrication, a composite slurry is meticulously formulated to ensure uniform dispersion, optimal rheology, and structural integrity of the final electrode film. The preparation begins with the dissolution of 5% by weight polyvinylidene fluoride (PVDF) in N-methyl-2-pyrrolidone (NMP), a high-boiling, polar aprotic solvent known for its compatibility with PVDF and ability to form stable polymer solutions. This dissolution process is carried out under continuous magnetic stirring at an elevated temperature of 80° C. for one hour, which enables the complete solubilization of PVDF by disrupting its semi-crystalline domains, yielding a homogenous and viscous polymer matrix.

Once a uniform PVDF solution is achieved, 90% by weight of the ZnO/NiO nanocomposite and 5% carbon black-used to enhance electrical conductivity are incrementally introduced into the solution. This addition is performed under vigorous vortex agitation, which is essential to ensure even dispersion of solid particles and to prevent phase separation that may result from the settling of higher-density nanoparticles. The stepwise incorporation allows progressive thickening of the slurry while maintaining manageable viscosity and avoiding the formation of agglomerates or unreacted polymer pockets.

The final slurry is adjusted to maintain a viscosity in the range of 500 to 700 centipoise (cP), a range empirically determined to provide the best balance between spreadability and film integrity during deposition. This rheological property ensures that the slurry can be uniformly applied onto a 3D porous nickel foam substrate without overpenetration or surface pooling. A consistent coating thickness across the substrate is critical for achieving uniform current distribution and electrochemical response during device operation.

Following deposition, the electrode-coated substrate undergoes a controlled, two-stage drying process. Initially, it is air-dried at ambient temperature for 2 hours to allow for gradual evaporation of NMP, reducing the risk of surface cracking or film delamination caused by rapid solvent loss. This is followed by vacuum drying at approximately 50° C. within a humidity-controlled chamber maintaining relative humidity below 10%. The low-temperature vacuum environment ensures the complete removal of residual NMP while preventing thermal degradation of the PVDF binder and avoiding the uptake of ambient moisture, which could compromise interparticle adhesion and electrode longevity.

This detailed approach to slurry formulation and electrode processing ensures the resulting electrode exhibits high mechanical integrity, uniform porosity, and enhanced electrochemical performance. The precise control of viscosity, drying kinetics, and moisture content supports excellent interface stability between active materials and the conductive network, which is crucial for applications in batteries, supercapacitors, and hybrid energy storage systems.

In an embodiment, prior to the addition of the fuel, a chelating agent selected from the group consisting of citric acid, ethylenediamine, or nitrilotriacetic acid is added to the aqueous solution containing the dissolved Zinc nitrate hexahydrate and Nickel(II) nitrate hexahydrate, wherein the chelating agent is added in a molar ratio of 1:1 with the total metal ion concentration to form stable metal-ligand complexes, and wherein this chelation step delays premature hydrolysis of metal ions and enables controlled combustion by altering the decomposition pathway of the metal precursors.

In an alternative embodiment designed to enhance the chemical stability and combustion dynamics of the precursor solution, a chelation strategy is employed prior to the introduction of the fuel components. Specifically, a chelating agent selected from the group consisting of citric acid, ethylenediamine, or nitrilotriacetic acid is added to the aqueous solution containing the fully dissolved Zinc nitrate hexahydrate and Nickel(II) nitrate hexahydrate.

This addition is carried out in a molar ratio of 1:1 relative to the total concentration of metal ions (i.e., the combined molarity of Zn²⁺ and Ni²⁺), ensuring stoichiometric complexation between the chelating ligand and the metal centers.

The primary role of the chelating agent in this context is to form stable, water-soluble metal-ligand complexes through coordination interactions. For example, citric acid acts as a multidentate ligand, forming inner-sphere complexes by binding via its carboxyl and hydroxyl functional groups. This complexation substantially reduces the availability of free metal ions in solution, which in turn inhibits their tendency to undergo hydrolysis—a common issue in aqueous systems that leads to the formation of metal hydroxide precipitates such as Zn(OH)₂ or Ni(OH)₂. By stabilizing the metal ions in a chelated form, this approach ensures a clear, homogeneous solution that remains chemically active without generating unwanted solid by-products prior to the combustion step.

Beyond solution stability, the inclusion of a chelating agent fundamentally alters the decomposition pathway of the metal precursors during combustion. Metal-chelate complexes typically exhibit different thermal degradation behavior compared to free metal nitrates. The coordinated structure delays the release of metal ions and modulates the timing of redox reactions during thermal treatment. This alteration leads to a more gradual and controlled release of energy, avoiding the violent exothermic bursts often associated with direct nitrate-fuel reactions. The combustion reaction, as a result, becomes more uniform and self-limiting, producing a finer, more evenly distributed oxide product with reduced agglomeration and improved crystallinity.

Moreover, the decomposition of chelated complexes often yields in situ carbonaceous frameworks that act as transient templates for nanoparticle formation, contributing to the development of porous morphologies with higher surface areas. This is particularly advantageous for electrochemical applications, where increased surface area and uniform particle dispersion translate directly into enhanced charge storage capacity, faster ion diffusion, and better cycling stability. Thus, the use of chelating agents not only prevents undesirable precursor precipitation but also acts as a combustion moderator and structural director, ultimately improving both the processability and functional performance of the resulting NiO/ZnO nanocomposite materials.

In an embodiment, after the stirring step and prior to the combustion step, the homogeneous precursor solution is subjected to a controlled pre-decomposition treatment in a nitrogen-purged chamber at 150° C. for 30 minutes, wherein this step induces partial evaporation of volatile organics and results in the formation of a gel-like mass that exhibits enhanced exothermicity during subsequent high-temperature combustion, and wherein the pre-decomposed material leads to finer particle morphology and reduced agglomeration in the final nanopowder, and wherein the glucose and/or urea fuel is chemically modified prior to addition by reacting it with phosphoric acid to form a phosphorylated intermediate fuel complex, wherein this functionalization introduces additional oxygen-containing species that participate in the redox balance of the combustion process, and wherein the phosphorylated fuel leads to enhanced combustion enthalpy and formation of doped oxide species with higher surface area and defect density.

In another refined embodiment aimed at modulating both the thermal behavior and morphological characteristics of the final NiO/ZnO nanopowder, the homogeneous precursor solution-formed after complete dissolution and stirring of metal nitrates with fuel—is subjected to a controlled pre-decomposition treatment before entering the main combustion phase. This intermediate thermal conditioning is conducted in a nitrogen-purged chamber at 150° C. for a duration of 30 minutes. The nitrogen atmosphere plays a critical role in maintaining an inert, non-oxidative environment, thereby preventing uncontrolled premature combustion. During this pre-decomposition step, a significant portion of the volatile organics, such as residual solvent molecules and loosely bound gases, are gently driven off. Simultaneously, the heat induces partial crosslinking among the fuel and metal-ligand complexes, transforming the fluid precursor into a semi-solid, gel-like mass.

This transitional gel structure is thermochemically more stable yet retains latent reactivity. It exhibits enhanced exothermicity when later exposed to higher combustion temperatures due to the more concentrated and spatially confined distribution of reactive intermediates. The gel's increased viscosity and cohesive nature also serve to inhibit bulk particle growth during combustion, leading to the generation of finer and more uniformly dispersed nanoparticles with significantly reduced agglomeration. This morphological refinement translates to increased surface area and improved electrochemical accessibility of the synthesized NiO/ZnO nanocomposite.

Additionally, the chemical composition of the fuel is modified prior to its addition to the metal nitrate solution. Specifically, glucose and/or urea—acting as the primary fuel—are reacted with phosphoric acid to form phosphorylated intermediate complexes. This functionalization process introduces phosphate and oxygen-containing moieties into the molecular structure of the fuel, enhancing its oxidative potential and modifying its decomposition pathway. Upon heating, the phosphorylated fuels release additional reactive oxygen species, which integrate into the redox balance of the system, supporting a more intense and energetically favorable combustion reaction.

The benefits of this dual strategy—pre-decomposition and fuel functionalization—are multifold. The intensified combustion enthalpy arising from the phosphorylated fuel not only ensures complete reaction of the metal precursors but also facilitates the in situ doping of the final oxide matrix with phosphorus or phosphate species. These dopants create localized defect structures and oxygen vacancies within the NiO/ZnO crystal lattice, which are known to enhance electronic conductivity, catalytic activity, and charge storage performance. Thus, the embodiment provides a synergistic approach that integrates physical restructuring of the precursor with chemical modification of the fuel to produce high-performance doped metal oxide nanomaterials with fine-tuned surface and electronic properties suitable for next-generation energy, sensor, and catalytic applications.

In an embodiment, prior to the combustion step, the homogeneous solution is irradiated using microwave energy at a frequency of 2.45 GHz for 5 minutes at 300 W, wherein this microwave-assisted pre-treatment initiates mild crosslinking between metal-ligand complexes and the fuel molecules, and wherein this pre-conditioning reduces the activation energy required for spontaneous combustion, thereby enhancing particle uniformity and phase purity, and wherein the combustion reaction is carried out under real-time thermal imaging using an infrared (IR) camera capable of detecting temperature variations across the reaction surface, wherein thermal gradients are analyzed during combustion to detect premature quenching or non-uniform ignition zones, and wherein adaptive thermal control is employed to maintain a stable reaction temperature range of 445° C. to 455° C. through dynamic feedback control of the muffle furnace power input.

In yet another advanced embodiment, the homogeneous precursor solution—comprising dissolved zinc and nickel nitrates, chelating agents, and fuel components—is subjected to a targeted microwave-assisted pre-treatment prior to initiating the combustion synthesis. This step involves irradiating the solution with microwave energy at a standardized frequency of 2.45 GHz for a duration of 5 minutes at a power setting of 300 W. The use of microwave radiation at this frequency induces rapid dielectric heating within the solution, which selectively excites polar molecules such as water, urea, and phosphate-functionalized glucose. This energy absorption facilitates localized temperature rise and promotes mild crosslinking interactions between the metal-ligand complexes and the fuel molecules.

This microwave-induced pre-conditioning offers several technical advantages. It reduces the overall activation energy barrier for subsequent spontaneous combustion by partially initiating low-energy thermal interactions between oxidizing and reducing components. These interactions promote the formation of highly reactive intermediate species and a pre-gelled matrix, which leads to a more homogeneous combustion front and significantly enhances the particle size uniformity and phase purity of the final oxide product. The initiation of bonding between ligands and metal centers during microwave treatment also stabilizes the precursor microstructure, minimizing inhomogeneous hot spots and stochastic particle growth during the main combustion event.

The combustion process following this pre-treatment is carefully monitored in real time using an infrared (IR) thermal imaging camera. This imaging system provides spatially resolved temperature maps of the reaction surface, allowing the detection of thermal gradients, ignition propagation fronts, and potential zones of premature quenching or uneven heating. Such monitoring is critical for ensuring that the combustion reaction remains uniformly exothermic and proceeds efficiently throughout the entire precursor volume.

To maintain optimal combustion conditions, adaptive thermal control is implemented through a dynamic feedback loop that adjusts the muffle furnace's power input based on real-time temperature data. Specifically, the furnace temperature is regulated to remain within the narrow range of 445° C. to 455° C., a window that has been empirically determined to support complete combustion while preventing overheating or sintering of the nanoparticles. This precision thermal management ensures reproducible product quality, consistent crystallite size, and controlled morphology.

In an embodiment, after grinding the powder, the material is subjected to post-synthesis acid etching using 0.1 M hydrochloric acid solution for 10 minutes under magnetic stirring, wherein the acid selectively removes surface-bound unreacted metallic species or secondary phases, and wherein the etched product is subsequently washed with ethanol and dried under vacuum to yield a high-purity NiO/ZnO nanocomposite with exposed surface active sites, and wherein prior to fuel addition, a redox potential tuning step is introduced by bubbling a reducing gas such as hydrogen or forming gas through the nitrate solution for 10 minutes, wherein this step reduces a fraction of Ni²⁺ ions to Ni⁺ in situ without precipitating metallic nickel, thereby altering the redox dynamics during combustion, and wherein this redox-modified solution produces nanoparticles with altered electronic properties and enhanced charge storage capacity.

In an embodiment designed to enhance both the purity and functional performance of the synthesized NiO/ZnO nanocomposite, a post-combustion purification and pre-combustion redox tuning strategy is employed. After the nanopowder is mechanically ground to achieve uniform particle size distribution, the material undergoes a selective acid etching process using a 0.1 M hydrochloric acid (HCl) solution. This treatment is conducted under magnetic stirring for 10 minutes, allowing uniform exposure of the powder surface to the acid. The primary objective of this step is to eliminate residual surface-bound species that may not have fully reacted during combustion—such as free Ni or Zn ions, or secondary oxide phases like Ni₂O₃ or Zn(OH)₂—that can compromise the structural integrity and electrochemical performance of the final material. The etching process effectively removes these unwanted impurities while preserving the crystalline framework of the primary NiO and ZnO phases.

Following acid treatment, the nanopowder is thoroughly washed with ethanol to neutralize any remaining acid and remove polar residues. Ethanol is chosen due to its miscibility with water and its ability to rapidly displace surface-bound species without damaging the delicate nanostructure. The washed powder is then dried under vacuum conditions to prevent atmospheric contamination and ensure the recovery of a high-purity, moisture-free NiO/ZnO nanocomposite. Importantly, the acid etching step also increases the density of exposed active surface sites by removing passivating impurities, thereby enhancing the material's electrochemical reactivity in applications such as supercapacitors or electrocatalysis.

Prior to the combustion synthesis, a redox potential tuning step is incorporated to further tailor the properties of the final product. Specifically, a reducing gas such as hydrogen or a hydrogen-nitrogen mixture (commonly referred to as forming gas) is bubbled through the metal nitrate precursor solution for a controlled duration of 10 minutes. This process induces partial reduction of Ni²⁺ ions to Ni⁺ species while maintaining the ions in solution without triggering precipitation of elemental nickel. The redox environment of the precursor solution is thereby adjusted to a lower oxidative state, which influences the combustion chemistry during synthesis. This controlled partial reduction shifts the redox balance and modifies the energy profile of the combustion process, ultimately altering the electronic structure and defect distribution in the resulting oxide nanoparticles.

The resultant redox-modified NiO/ZnO nanomaterials exhibit distinct improvements in electronic conductivity and charge carrier mobility due to the presence of additional oxygen vacancies and altered oxidation states within the Ni sublattice. These features are particularly beneficial for energy storage devices, as they facilitate faster ion/electron transport and increase the effective capacitance or catalytic activity of the material. Therefore, the combined approach of post-synthesis acid etching and pre-synthesis redox tuning provides a robust methodology to fine-tune the physical, chemical, and electrochemical attributes of NiO/ZnO nanocomposites, rendering them more suitable for high-performance applications.

In an embodiment, an organosilane compound selected from the group consisting of tetraethyl orthosilicate (TEOS), methyltrimethoxysilane (MTMS), or aminopropyltriethoxysilane (APTES) is added in a concentration of 0.5-1.0 wt % to the aqueous metal nitrate solution prior to the fuel addition step, wherein the organosilane undergoes partial hydrolysis and condenses during the combustion process to form silica nanodomains, and wherein the resulting NiO/ZnO nanoparticles exhibit enhanced dispersion stability and reduced particle-particle agglomeration due to in situ siloxane passivation.

In this embodiment, a strategy is employed to control nanoparticle agglomeration and enhance the colloidal stability of the final NiO/ZnO nanocomposite by introducing a small quantity of an organosilane compound into the precursor solution. Specifically, an organosilane selected from tetraethyl orthosilicate (TEOS), methyltrimethoxysilane (MTMS), or aminopropyltriethoxysilane (APTES) is added at a concentration between 0.5-1.0 wt % to the aqueous solution containing dissolved Zinc nitrate hexahydrate and Nickel(II) nitrate hexahydrate. This addition is carried out before the incorporation of the fuel components to ensure uniform interaction of the silane with the metal ions and the aqueous matrix.

Upon introduction into the aqueous environment, the organosilane undergoes partial hydrolysis, a process catalyzed by the inherent moisture and slightly acidic pH of the nitrate solution. During hydrolysis, the alkoxy groups (—OR) of the silane compounds are replaced by hydroxyl groups (—OH), generating silanol (Si—OH) intermediates. These silanols then undergo condensation reactions, either with each other or with hydroxyl groups present on the surface of forming metal hydroxide or oxide clusters. This results in the formation of dispersed silica nanodomains or Si—O-M (M=Ni, Zn) linkages, which are integrated into the combustion matrix.

During the high-temperature combustion step, the condensation of silanol groups continues, leading to the in situ formation of amorphous or semi-crystalline siloxane (Si—O—Si) networks that encapsulate or decorate the growing NiO and ZnO particles. This surface passivation via siloxane formation inhibits uncontrolled grain growth and prevents direct particle-particle fusion, which are common challenges in combustion synthesis due to the intense exothermic conditions. As a result, the final nanomaterial exhibits significantly reduced agglomeration, with individual or loosely bound nanoparticles instead of large, fused aggregates.

Moreover, the silica nanodomains impart steric and electrostatic stabilization to the colloidal suspension of the nanoparticles, enhancing dispersion stability in post-synthesis processing steps such as slurry preparation, coating, or ink formulation. The presence of silica also introduces surface functionality that can serve as a platform for further chemical modification or compatibility with polymer matrices in device fabrication.

The integration of organosilane chemistry into the combustion synthesis workflow adds a powerful dimension of structural control and surface engineering. It yields NiO/ZnO nanocomposites with improved morphological uniformity, enhanced processability, and better performance consistency in electrochemical, sensing, or catalytic applications. The siloxane-passivated particles retain high surface area and functional surface sites, while their reduced aggregation leads to better utilization of active material and increased reproducibility in device performance.

In an embodiment, an ionic liquid selected from the group consisting of 1-butyl-3-methylimidazolium tetrafluoroborate, 1-ethyl-3-methylimidazolium acetate, or choline chloride-urea deep eutectic solvent is used as a partial replacement (10-30 vol %) for the aqueous solvent during metal nitrate dissolution, wherein the ionic liquid acts as both a solvothermal modifier and structural directing agent during combustion, and wherein the ionic liquid-assisted route leads to tailored nanostructures with anisotropic growth patterns and controlled aspect ratios.

In an embodiment focused on morphological control and nanostructure tuning, the aqueous medium conventionally used for dissolving Zinc nitrate hexahydrate and Nickel(II) nitrate hexahydrate is partially substituted by 10% to 30% by volume—with an ionic liquid (IL) selected from the group consisting of 1-butyl-3-methylimidazolium tetrafluoroborate, 1-ethyl-3-methylimidazolium acetate, or a choline chloride-urea deep eutectic solvent. The incorporation of these ionic liquids, which possess unique physicochemical properties such as low volatility, high thermal stability, strong ionic conductivity, and tunable polarity, introduces a dual-functionality into the precursor system: acting both as a solvothermal modifier and as a structural directing agent during the combustion process.

During the dissolution phase, the IL co-solvent interacts with metal ions and nitrate anions, altering the solvation shell structure and slowing down the hydration kinetics of Zn²⁺ and Ni²⁺. This modified ion-solvent environment leads to the formation of more structured metal-ion complexes, often involving direct coordination with IL components or hydrogen bonding networks. As a result, the spatial arrangement of reactants is altered at the molecular level, which has significant consequences for the combustion dynamics and the resulting particle morphology.

Upon heating during the combustion step, the IL does not merely volatilize or decompose passively. Instead, it actively participates in templating processes through supramolecular interactions and controlled release of thermal energy. For instance, in the case of 1-butyl-3-methylimidazolium tetrafluoroborate, the imidazolium ring may act as a soft template by interacting with the nascent oxide clusters, promoting anisotropic growth along preferred crystallographic directions. Similarly, deep eutectic solvents like choline chloride-urea can form extensive hydrogen bonding networks that influence the gelation and spatial distribution of metal ions prior to combustion.

These templating and directing effects result in the formation of nanostructures with tailored morphologies, including nanorods, nanoplates, or other anisotropic geometries, instead of randomly agglomerated nanoparticles. Furthermore, the presence of IL residues during combustion serves to moderate the rate of combustion propagation, thereby reducing thermal gradients and suppressing uncontrolled nucleation events.

The ability to achieve controlled aspect ratios and anisotropic growth patterns directly enhances the functional performance of the resulting NiO/ZnO nanocomposites. For instance, one-dimensional or platelet-like structures exhibit higher active surface area-to-volume ratios and offer more accessible electrochemical interfaces for charge transfer. Additionally, anisotropic nanostructures typically provide enhanced electron mobility and ion diffusion pathways, critical parameters in applications such as energy storage, photocatalysis, and gas sensing.

Thus, the use of ionic liquids as partial aqueous replacements represents a significant advancement in combustion synthesis, enabling bottom-up structural control, improved thermal management, and enhanced nanoscale precision in tailoring the properties of NiO/ZnO composites.

In an embodiment, a halide salt selected from the group consisting of potassium iodide, lithium chloride, or ammonium fluoride is introduced at trace concentrations (<0.5 mol %) into the precursor solution, wherein the halide species transiently coordinate with Zn²⁺ and Ni²⁺ ions to disrupt lattice symmetry during combustion, and wherein post-synthesis annealing volatilizes the halide residues, leaving behind lattice strain-induced oxygen vacancies that enhance electrochemical reactivity.

In a further embodiment designed to engineer point defects and improve the electrochemical activity of the synthesized NiO/ZnO nanomaterials, a halide salt selected from the group consisting of potassium iodide (KI), lithium chloride (LiCl), or ammonium fluoride (NH₄F) is introduced into the metal nitrate precursor solution at a trace concentration of less than 0.5 mol %. These halide species are chosen due to their high ionic mobility, small ionic radii (except iodine, which is intentionally larger for creating more extensive lattice distortion), and their ability to transiently coordinate with divalent Zn²⁺ and Ni²⁺ ions through halide-metal ion interactions. Once added, these halide ions form weakly bound metal-halide complexes, subtly altering the electronic environment and disrupting the typical octahedral coordination geometry of the metal cations.

During the combustion process, these transient halide-metal interactions persist briefly at elevated temperatures, affecting the crystallization dynamics and leading to non-equilibrium lattice configurations. Specifically, the coordination of halides induces localized lattice strain, which interferes with the symmetric packing of the growing oxide lattices. This intentional disruption results in the formation of microstructural defects, such as oxygen vacancies and dislocations, which are embedded into the lattice during the rapid solidification phase post combustion. These defects are especially significant because they serve as active sites for redox reactions and improve ionic conductivity-key attributes for applications such as supercapacitors, batteries, and electrochemical sensors.

To ensure that no residual halide species compromise the purity or long-term stability of the product, a post-synthesis annealing step is employed. Typically conducted at 500-600° C. under an inert or air atmosphere, this heat treatment volatilizes the halide residues due to their low decomposition temperatures or sublimation under thermal conditions. The removal of these species leaves behind strain-induced oxygen vacancies that are thermodynamically stabilized within the NiO and ZnO lattices. Importantly, the vacancies are not random but are instead distributed in a quasi-controlled fashion, dictated by the original halide-induced symmetry disruptions.

These oxygen vacancies significantly enhance the electrochemical reactivity of the nanocomposite by increasing charge carrier density and enabling faster electron and ion transport through the material. In practical terms, this means improved rate capability, lower charge-transfer resistance, and enhanced capacitance or catalytic turnover in the final device architecture. This halide-assisted strategy provides a scalable and chemically straightforward method to introduce functional defects without the need for high-energy milling or plasma treatment, thereby preserving the morphological integrity and nanoscale dimensions of the synthesized NiO/ZnO materials.

In an embodiment, the nitrate solution is supplemented with a redox mediator compound selected from the group consisting of 1,4-benzoquinone, potassium ferrocyanide, or sodium thiosulfate prior to the addition of the fuel, wherein the redox mediator modulates the combustion front propagation velocity by buffering electron transfer steps between oxidant and fuel molecules, and wherein the use of such mediator yields more uniform thermal gradients during combustion and results in narrower nanoparticle size distributions.

In an embodiment that focuses on enhancing thermal uniformity and refining nanoparticle size distribution during combustion synthesis, the nitrate precursor solution is supplemented with a redox mediator compound prior to the addition of the fuel. The redox mediator is selected from a group including 1,4-benzoquinone, potassium ferrocyanide, or sodium thiosulfate, each of which possesses well-defined redox potentials and the ability to reversibly participate in electron transfer processes. These compounds are introduced in trace but stoichiometrically relevant concentrations into the aqueous solution containing dissolved Zinc nitrate hexahydrate and Nickel(II) nitrate hexahydrate.

The primary role of the redox mediator is to modulate the combustion front propagation by acting as an intermediate buffer in the electron transfer chain between the oxidizing metal nitrate ions and the reducing fuel components (e.g., glucose and urea). In conventional combustion synthesis, redox reactions between fuel and oxidizer can proceed rapidly and unevenly, generating steep thermal gradients that lead to hotspots, localized over-reactions, and uneven particle nucleation. The incorporation of a redox mediator addresses this by decoupling the direct redox coupling of oxidizer and reducer, allowing the mediator to transiently accept and donate electrons. For example, 1,4-benzoquinone can be reversibly reduced to hydroquinone, temporarily stabilizing electron flow, while potassium ferrocyanide can facilitate multielectron shuttling due to its Fe(II)/Fe(III) redox couple.

This buffered electron transfer modulates the rate of combustion propagation, preventing runaway exothermicity and smoothing out thermal gradients across the reaction medium. As a result, the reaction evolves more uniformly through the precursor matrix, enabling controlled nucleation and growth of oxide nanocrystals. This suppression of rapid, localized ignition prevents large-scale sintering or coalescence of particles, thereby promoting the formation of nanoparticles with narrower size distributions and more consistent morphology.

Post-synthesis characterization of products synthesized via this redox-mediator-assisted route typically reveals a marked reduction in the standard deviation of particle sizes, along with enhanced homogeneity in terms of crystallinity and surface texture. Furthermore, the uniformity in thermal treatment also improves phase purity, reducing the likelihood of mixed oxide or suboxide formation due to incomplete combustion or over-oxidation at localized hot zones.

The resulting NiO/ZnO nanomaterials exhibit improved batch-to-batch reproducibility, optimized textural properties, and enhanced suitability for integration into electrochemical devices, sensors, and catalytically active systems.

In an embodiment, a metal-organic framework (MOF) precursor selected from the group consisting of ZIF-8, Ni-BDC, or Zn-Triazole complexes is added as a solid templating agent in the amount of 3-10 wt % prior to the combustion step, wherein the MOF thermally decomposes in situ to provide a porous scaffold and release coordinated metal ions that integrate into the NiO/ZnO lattice, and wherein the resulting composite exhibits hierarchical porosity and increased electrochemical active surface area.

In an embodiment directed toward engineering hierarchical porosity and enhancing electrochemical performance, a metal-organic framework (MOF) precursor is incorporated into the combustion synthesis route as a solid templating and metal-donating agent. A MOF selected from the group consisting of ZIF-8 (Zeolitic Imidazolate Framework-8), Ni-BDC (Nickel-based 1,4-benzenedicarboxylate), or Zn-Triazole complex is added to the homogeneous precursor mixture in an amount ranging from 3 to 10 wt % prior to the combustion step. These MOFs, characterized by their crystalline, porous structures and high thermal sensitivity, are uniformly dispersed into the solution containing dissolved metal nitrates and fuel under controlled agitation.

The addition of the MOF serves a dual function. First, during the high-temperature combustion process, the MOF undergoes rapid thermal decomposition, releasing volatile organic linkers and leaving behind a porous carbonaceous or oxide residue. This in situ decomposition provides a sacrificial scaffold that promotes the formation of a sponge-like, interconnected porous matrix within the evolving NiO/ZnO nanocomposite. Second, the coordinated metal ions within the MOF—such as Zn²⁺ from ZIF-8 or Ni²⁺ from Ni-BDC—are released into the reaction medium as thermally labile complexes. These ions participate in the combustion redox reactions and integrate directly into the forming oxide lattice, contributing to overall phase homogeneity and compositional control.

As the combustion proceeds, the structural remnants of the MOF define localized voids and channels within the growing oxide framework, yielding a composite material characterized by hierarchical porosity. This includes micropores derived from the original MOF structure, mesopores from interparticle spacing, and macropores from combustion-induced gas evolution. Such multiscale porosity drastically increases the electrochemically active surface area, thereby enhancing the accessibility of redox-active sites and facilitating efficient electrolyte penetration and ion diffusion when the material is deployed in devices such as supercapacitors or batteries.

The presence of the MOF-derived template not only improves surface architecture but also imparts a degree of crystallographic texture, potentially directing preferential orientation of the growing oxide nanocrystals. Furthermore, the localized release of metal ions from MOF decomposition ensures uniform metal dispersion, which minimizes the formation of secondary phases and improves compositional uniformity.

Consequently, this MOF-assisted combustion synthesis pathway results in NiO/ZnO nanocomposites with superior textural, electrochemical, and morphological attributes. The materials exhibit enhanced charge storage capabilities, improved rate performance, and long-term cycling stability, making them highly suitable for integration into next-generation energy storage and conversion platforms. This embodiment effectively leverages the unique structural and chemical properties of MOFs to create a self-templating, metal-enriched synthesis environment within a combustion framework.

In an embodiment, a volatile organic acid selected from the group consisting of formic acid, propionic acid, or trifluoroacetic acid is added to the metal nitrate solution in a molar ratio of 0.2-0.5 relative to total metal ions, wherein the acid functions as both a complexing agent and a combustion modifier that lowers ignition delay by generating reactive intermediate metal-carboxylate complexes, and wherein the evolved gas species during combustion include formate or fluoroform by-products that aid pore formation and nano-scaling of the oxide product.

In an embodiment designed to fine-tune combustion kinetics and enhance the structural features of the resulting oxide nanomaterial, a volatile organic acid selected from the group consisting of formic acid, propionic acid, or trifluoroacetic acid is added to the aqueous metal nitrate solution prior to fuel incorporation. This addition is performed in a molar ratio of approximately 0.2 to 0.5 with respect to the total metal ion concentration (combined Zn²⁺ and Ni²⁺), ensuring a stoichiometrically balanced introduction of the acid without excessively altering the solution's redox profile or pH stability.

The inclusion of these low-molecular-weight carboxylic acids serves a dual functional role. First, they act as complexing agents, forming intermediate metal-carboxylate complexes with the dissolved Zn²⁺ and Ni²⁺ ions. These coordination complexes—such as nickel formate or zinc trifluoroacetate—modify the thermal decomposition pathway of the metal precursors. Unlike nitrate salts, which typically decompose explosively and rapidly under high-temperature combustion, the carboxylate intermediates exhibit smoother, more progressive degradation profiles. This alteration results in reduced ignition delay and a more gradual energy release, creating a controlled combustion environment that fosters uniform nucleation and nano-scaling of the oxide particles.

Second, these acids act as combustion modifiers. During thermal decomposition, they generate highly volatile by-products—such as CO₂, water vapor, formate species, or fluoroform (CHF₃)—that contribute to gas evolution and foaming during the combustion process. The rapid release of these gases introduces additional porosity into the reacting matrix, facilitating the formation of highly porous structures and preventing particle sintering. The effect is particularly pronounced with trifluoroacetic acid, which not only contributes to gas evolution but also imparts localized cooling through endothermic volatilization, further aiding in the control of particle size and suppression of agglomeration.

The outcome of this approach is the formation of NiO/ZnO nanocomposites characterized by ultrafine particle sizes, high surface-to-volume ratios, and well-distributed nanoscale porosity. These structural attributes are highly beneficial for enhancing electrochemical performance, as they allow for faster ion diffusion, increased electroactive surface area, and more efficient charge storage or catalytic activity. Furthermore, the integration of these volatile acids into the precursor design offers a scalable, solution-phase technique for tuning combustion dynamics without the need for complex equipment or multistep processing. The use of volatile organic acids such as formic, propionic, or trifluoroacetic acid provides a highly effective means of engineering metal oxide nanostructures with superior morphological and functional properties by acting synergistically as both complexing and combustion-modifying agents.

In an embodiment, after the homogeneous solution is prepared, a pulsed electric field (PEF) treatment is applied using electrodes immersed in the solution, wherein pulsed voltages in the range of 500-1000 V/cm are applied at a frequency of 1-5 Hz for a duration of 2-3 minutes, and wherein this treatment induces transient electrophoretic migration of ionic species to enhance precursor homogenization, pre-nucleation structure ordering, and ultimately yields smaller, more uniform nanoparticles post combustion, wherein a photosensitive compound selected from the group consisting of azobenzene derivatives, spiropyran, or diazonium salts is added in a concentration of 0.1-0.3 wt % to the precursor mixture, wherein the solution is irradiated with UV light at 365 nm for 5 minutes prior to combustion to activate molecular conformation changes in the additive, and wherein the activated state contributes additional thermal energy release upon combustion initiation, resulting in localized microburst combustion zones and fractal-like surface morphologies in the synthesized nanoparticles.

In a highly engineered embodiment aimed at enhancing both the physicochemical ordering of the precursor solution and the resulting structural complexity of the NiO/ZnO nanoparticles, a dual-field activation approach is employed following the preparation of the homogeneous metal nitrate-fuel solution. The first step involves the application of a pulsed electric field (PEF) treatment using immersed electrodes in the precursor solution. Pulsed voltages ranging between 500 and 1000 V/cm are applied at frequencies between 1 and 5 Hz for a duration of 2 to 3 minutes. The PEF induces transient electrophoretic migration of ionic species, particularly the Zn²⁺, Ni²⁺, nitrate ions, and fuel molecules, resulting in a reorganization of ionic distribution and enhanced homogenization at the molecular level.

This transient electrophoresis is key to promoting localized charge separation and controlled micro-environmental zones, which facilitate the establishment of pre-nucleation structures-small-scale, energetically favorable clusters of metal ions and ligands. These pre-nucleation domains act as uniform seeds for the subsequent nucleation and growth of oxide particles during combustion, leading to narrower size distributions and smaller, more uniformly dispersed nanoparticles in the final product. The PEF treatment effectively eliminates spatial heterogeneity within the solution that could otherwise lead to uneven combustion or agglomerated particle formation.

Following the PEF treatment, a photosensitive compound is introduced into the precursor solution. This additive is selected from a group including azobenzene derivatives, spiropyrans, or diazonium salts and is added in a concentration of 0.1-0.3 wt %. These compounds exhibit reversible photoisomerization or photo-decomposition when exposed to ultraviolet (UV) light. The solution is then irradiated at 365 nm for 5 minutes, a wavelength specifically chosen to activate these compounds without degrading other constituents in the precursor.

Upon UV exposure, the photosensitive additives undergo molecular conformation changes or photolytic cleavage that store potential energy in the form of activated intermediates. When the precursor is later introduced into the combustion furnace, these activated compounds contribute to localized microburst energy release at the ignition point. These rapid energy releases initiate highly localized, transient combustion zones-so-called “microbursts” which generate steep thermal gradients and rapid gas evolution at micron or sub-micron scales. This results in fractal-like surface morphologies and porous texturing of the resulting nanoparticles, which enhance the surface area and potentially introduce functional defects beneficial for electrochemical, photocatalytic, or sensor applications.

The PEF and UV/photoactivation steps provide a sophisticated pre-combustion conditioning method that tailors both the internal structure and surface architecture of the synthesized NiO/ZnO nanocomposite. This embodiment enables a higher degree of control over particle uniformity, defect generation, and porosity, contributing to improved charge transport, ion accessibility, and reactivity in advanced applications. Moreover, the approach is modular and scalable, suitable for integration into continuous or batch processing setups for functional nanomaterial production.

In an embodiment, a transition metal complex selected from the group consisting of nickel acetylacetonate, zinc citrate, or bis(ethylenediamine)nickel(II) chloride is added alongside the corresponding metal nitrate salts in a ratio of 1:4 (complex to nitrate), wherein the mixed precursor system alters the combustion dynamics by introducing ligated metal coordination spheres that decompose at staggered thermal thresholds, and wherein the controlled decomposition contributes to bimodal nanoparticle size distribution and multi-domain crystallinity in the final NiO/ZnO product, and wherein after the combustion synthesis and grinding steps, the nanopowder is subjected to a staged atmosphere-switching heat treatment, wherein the powder is first held at 300° C. in a flowing hydrogen-nitrogen gas mixture for 30 minutes, followed by re-oxidation at 400° C. in air for 1 hour, and wherein this dual-atmosphere cycling induces defect-engineered oxygen vacancies and reorients surface terminations of NiO and ZnO phases, thereby improving electronic conductivity and surface redox activity.

In a functionally advanced embodiment targeting tunable crystallinity, defect engineering, and enhanced electronic performance, a hybrid precursor approach is adopted by co-introducing transition metal complexes along with conventional metal nitrate salts. Specifically, a complexing agent selected from nickel acetylacetonate, zinc citrate, or bis(ethylenediamine)nickel(II) chloride is added to the precursor formulation in a ratio of 1:4 relative to the corresponding metal nitrate species. The inclusion of these pre-coordinated metal complexes introduces distinct metal-ligand coordination spheres that exhibit different thermal decomposition behaviors compared to simple metal nitrates. These complexes are thermally more stable and decompose at higher, staggered thresholds, thereby delaying the release of metal ions into the combustion matrix.

The staggered decomposition introduces a temporally controlled flux of metal species during combustion, effectively modulating the rate of oxide formation and energy release. This altered dynamic leads to a bimodal nanoparticle size distribution: smaller particles that nucleate rapidly from the nitrate-derived species, and larger crystallites that gradually form from the more thermally persistent metal-ligand complexes. Additionally, this dual-source precursor strategy facilitates the emergence of multi-domain crystallinity within individual particles or aggregates—regions within the same particle may crystallize in subtly different orientations or exhibit stacking disorder, which can be advantageous for catalytic and electrochemical applications due to increased defect density and domain boundaries.

Following combustion synthesis and mechanical grinding, the resulting NiO/ZnO nanopowder is subjected to a two-stage post-treatment involving controlled atmosphere switching to induce targeted defect engineering and surface restructuring. The powder is first annealed at 300° C. under a flowing hydrogen-nitrogen (forming gas) environment for 30 minutes. This reductive atmosphere selectively abstracts lattice oxygen atoms, creating oxygen vacancies while avoiding reduction of the entire oxide phase to metal. These vacancies serve as active sites for redox reactions and enhance charge transport pathways.

Subsequently, the atmosphere is switched to ambient air, and the material is re-oxidized at 400° C. for 1 hour. This reoxidation step partially heals structural damage from the reductive phase while preserving a significant population of stabilized oxygen vacancies and newly formed surface terminations, particularly hydroxyl or adsorbed oxygen species. These changes reorganize the surface chemistry of both NiO and ZnO phases, improving their electronic conductivity and reactivity toward charge carrier exchange and interfacial reactions.

The dual-atmosphere cycling treatment synergizes with the bimodal crystallinity to produce a material with a highly tailored combination of structural order, defect sites, and accessible electrochemical interfaces. The final NiO/ZnO nanocomposite exhibits superior electronic conductivity, increased surface redox activity, and enhanced performance in applications such as supercapacitors, lithium-ion batteries, photocatalytic hydrogen generation, or gas sensing. This embodiment thus provides a multifaceted strategy—starting from precursor chemistry to post-synthetic processing—for precisely engineering structure-property relationships in combustion-synthesized nanomaterials.

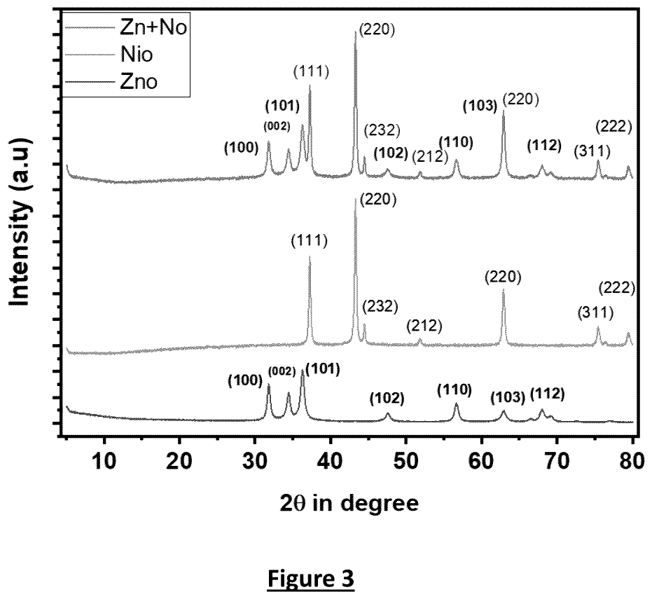

FIG. 3 illustrates a XRD pattern of ZnO and NiO and their composite. The XRD measurement was used to analyze phase information of the ZnO and NiO and their composite, and which is is displayed in FIG. 3. Three strong peaks can be found at 44.51°, 51.84°, and 76.41°, which corresponds to (110), (200), and (220) diffraction of Ni (JCPDS 65-2865). The XRD pattern revealed two diffraction peaks that corresponded well with the (100) and (101) planes of ZnO, as per JCPDS 36-1451. Additionally, a distinctive peak at 43.01° was observed, which aligns with the (200) planes of NiO, in accordance with JCPDS 47-1049. These findings indicate that the hybrid material contains two distinct phases, NiO and ZnO.

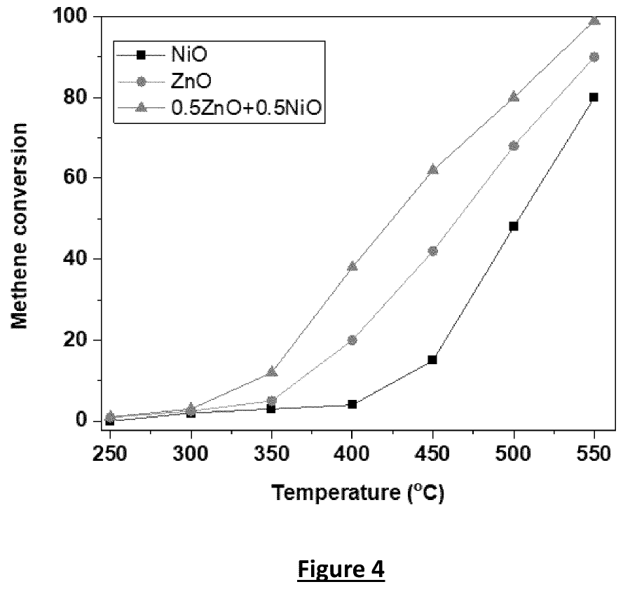

FIG. 4 illustrates a Light-off curves of methane combustion on Zno,Nio and ZnO/NiO composites. In order to assess the catalytic capabilities of the samples, experiments involving the combustion of catalytic methane were conducted. The results of these experiments are illustrated in the form of light-off curves, as depicted in FIG. 3. These light-off curves provide valuable insights into the catalytic activity of the tested materials by showing the temperature at which methane combustion initiates and progresses.

FIG. 4 presents a graph that plots the temperature of the methane combustion trajectory against the reaction rate, which is derived from the surface area reaction rate. This graph allows for a detailed analysis of the kinetics of methane combustion on the surface of the catalyst materials. By examining the relationship between temperature and reaction rate, it becomes possible to elucidate the efficiency and effectiveness of the catalysts in promoting methane combustion.

The data obtained from these experiments indicate that ZnO exhibits a relatively low degree of catalytic activity, as evidenced by the temperature at which methane is converted. This observation suggests that ZnO may not be highly effective as a catalyst for methane combustion under the tested conditions.

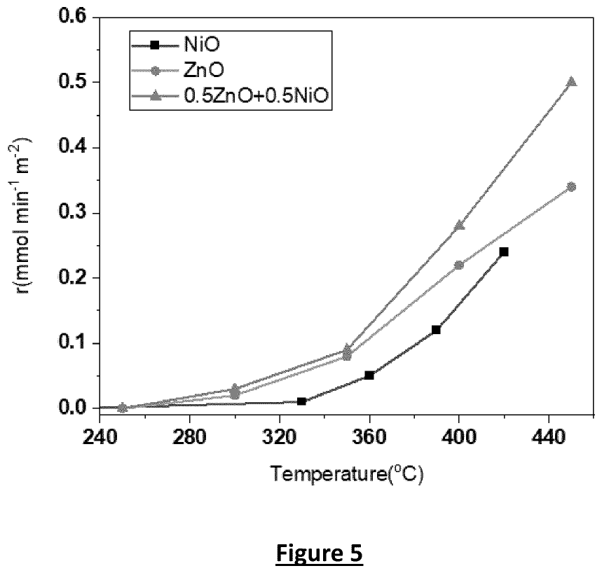

FIG. 5 illustrates Relationship between temperature and reaction rate for methane combustion (calculated by the surface area reaction rate). The observation that the performance of the methane catalytic reaction improves with increasing concentration of ZnO/NiO is evident from the data presented in FIG. 5. Specifically, it can be observed that the composite oxide composed of 05ZnO+0.5NiO exhibits the highest reaction rate among all samples. This suggests that the presence of ZnO/NiO enhances the catalytic activity of NiO for methane combustion.

When considering both FIG. 3 and FIG. 4 together, it becomes apparent that the 05ZnO+0.5NiO composite oxide displays the greatest level of catalytic activity for methane combustion compared to other samples. This conclusion is drawn from the comparison of catalytic activity levels across all samples tested.

The superior catalytic performance of the 05ZnO+0.5NiO composite oxide can be attributed to the synergistic effect between NiO and ZnO in the process of catalyzing methane combustion. The presence of NiO likely facilitates improved dispersion and accessibility of active sites on the catalyst surface, leading to enhanced catalytic activity. Additionally, the combination of NiO and ZnO may promote synergistic interactions that enhance the overall catalytic efficiency of the composite oxide. The evidence suggesting that NiO possesses strong methane adsorption capabilities provides valuable insights into the enhanced catalytic activity observed in the 0.5NiO+0.5ZnO composite during methane combustion. The ability of NiO to adsorb methane molecules likely contributes to the improved performance of the composite catalyst by facilitating the efficient interaction between methane and active sites on the catalyst surface.

Furthermore, considering that the methane content in the reaction conditions is typically around 2%, the significant enhancement in catalytic activity observed in the 0.5NiO+0.5ZnO composite becomes even more remarkable. This underscores the effectiveness of the composite catalyst in promoting methane combustion under realistic reaction conditions.

The proposed mechanism by Mars and van Krevelen for CH₄ oxidation reaction is widely accepted as valid and provides a theoretical framework for understanding the catalytic oxidation of methane. This mechanism involves the interaction of methane molecules with active oxygen species on the catalyst surface, leading to the formation of water and carbon dioxide as the main products of the combustion reaction.

The combination of NiO and ZnO in the composite catalyst synergistically enhances methane adsorption and catalytic activity, leading to improved performance in methane combustion. Further research into the underlying mechanisms and optimization strategies for composite catalysts containing NiO and ZnO holds promise for the development of highly efficient catalysts for methane oxidation and other environmental applications.

FIG. 4 illustrates the multiple distinct mechanisms through which NiO and ZnO may synergistically catalyze the combustion of methane. Methane molecules are primarily adsorbed onto the surface of NiO, while oxygen molecules predominantly adsorb to the oxygen vacancies present in the ZnO crystal structure.

At the interface between NiO and ZnO, the adsorbed methane and oxygen species participate in a redox process, leading to the production of water and carbon dioxide. This redox process involves the transfer of electrons between methane and oxygen species, facilitated by the active sites on the surfaces of both NiO and ZnO.

The high surface area and unique electronic properties of NiO make it an excellent substrate for methane adsorption, while the oxygen vacancies in the ZnO lattice provide reactive sites for oxygen adsorption and activation. The close proximity of NiO and ZnO in the composite catalyst promotes efficient electron transfer between adsorbed methane and oxygen species, facilitating the catalytic oxidation of methane to water and carbon dioxide.

Furthermore, the presence of NiO may also enhance the stability and dispersion of active sites on the ZnO surface, further promoting the catalytic activity of the composite catalyst. The synergistic interaction between ZnO and NiO enables efficient methane combustion by providing complementary pathways for methane adsorption, oxygen activation, and redox reactions at the catalyst surface.

### Supercapacitor Performance:

Fabrication of electrodes for supercapacitor study: The mass of the active materials, ZnO (0.0106 g), NiO (0.0109 g), and ZnO/NiO nanocomposite (0.0118 g), resulting in 90% of the samples, along with carbon black (5%), polyvinylidene fluoride (PVDF) (5%), were thoroughly mixed using a high-speed Vortex mixer at 600 rpm before getting coated on dry nickel foam (1 cm×1 cm). This was done in order to measure the electrochemical performance. The coated nickel foam underwent an overnight vacuum finish at 50° C. in a laboratory oven. Using an analytical balance, the electrode's weight was carefully determined before and after fabrication. Three electrodes were used in the electrochemical evaluations. All the sample-coated electrodes were used as a working electrode, calomel reference electrode and platinum wire counter electrode, in a 3 M KOH aqueous electrolyte. All the electrochemical characterization Cyclic voltammetry, FRA impedance was done by using a multichannel potentiostat/galvanostat (AUTOLAB M204.S, from Netherlands). The working voltage window of 0 to −1 V was used to record the results of the 3-electrode system.

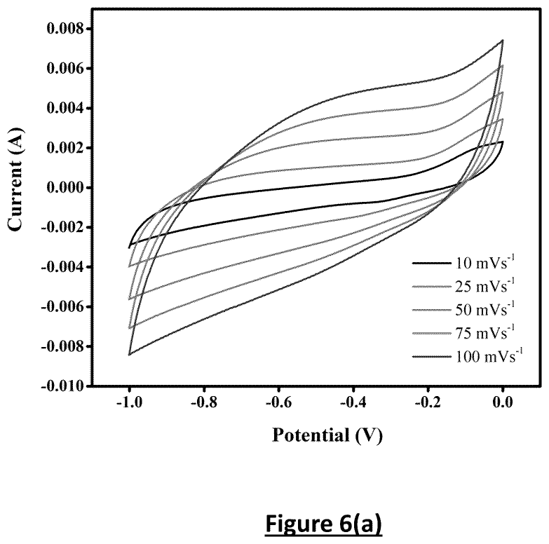

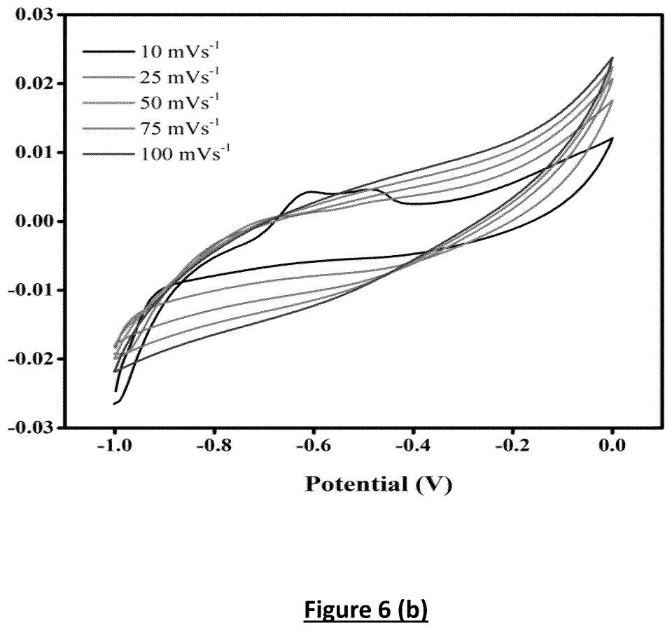

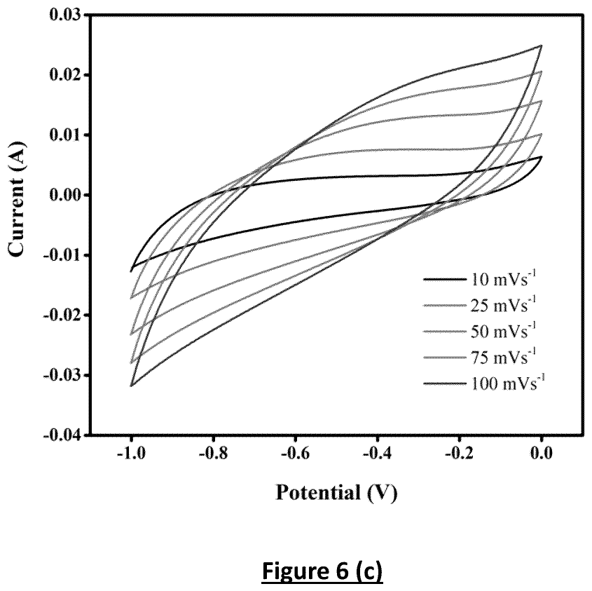

FIG. 6(a) illustrates Cyclic voltammetry study of ZnO at the different scan rates from 10 to 100 mV S⁻¹;

FIG. 6(b) illustrates Cyclic voltammetry study of NiO at the different scan rates from 10 to 100 mV S⁻¹;

FIG. 6(c) illustrates Cyclic voltammetry study of ZnO/NiO Composite at the different scan rates from 10 to 100 mV S⁻¹;

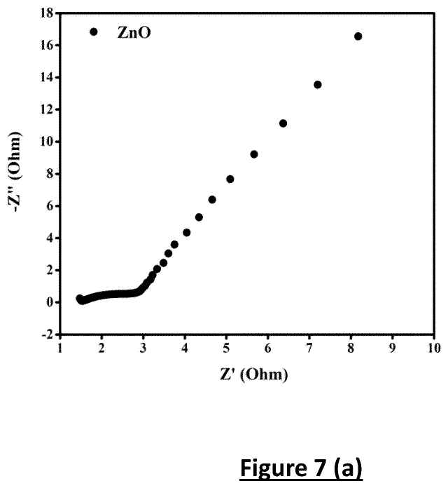

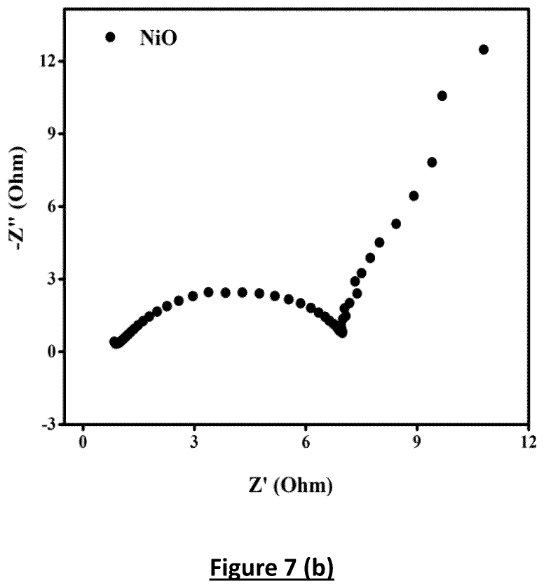

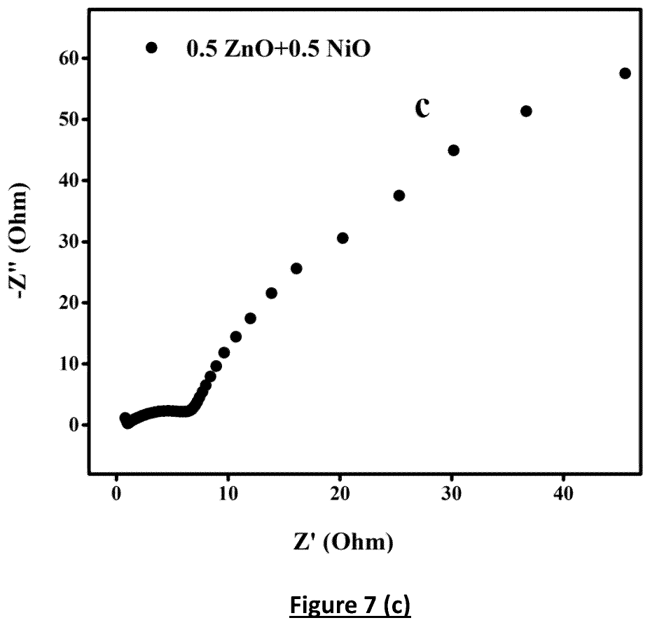

FIG. 7(a) illustrates FRA impedance analysis of pure NiO;

FIG. 7(b) illustrates FRA impedance analysis of ZnO;

FIG. 7(c) illustrates FRA impedance analysis of ZnO/NiO Composite;

Using CV and EIS measurements, the synthesized ZnO, NiO, and ZnO/NiO composite electrode were electrochemically studied. The CV cycles of the NiO, ZnO, and ZnO/NiO composite is shown in FIG. 7(a, b, c). As seen in FIG. 6 (a, b, c), every electrode was exposed to different scan speeds ranging from 10 to 100 mV s⁻¹. Every CV measurement was taken between 0 and −1 V of potential. At an increased scan rate of 100 mV s⁻¹, the ZnO/NiO electrode demonstrated a Faradic-redox behavior with reproducible oxidation-reduction curves. The ZnO/NiO electrode's good rate capacity was indicated by the redox curves' constant yet more prominent forms at lower scan speeds. All the samples have two redox peaks on their CV curves. The nature of this redox reaction is caused by the features of pseudocapacitance, and different reaction processes may produce different outcomes. Moreover, the equivalent capacitance increases with the area the CV curve surrounds. The more significant portions of the NiO and ZnO composite are clearly visible, suggesting that the addition of ZnO can raise the specific surface area and boost the composite's value relative to NiO alone.

EIS has assessed a significant aspect of the reaction kinetics for pseudocapacitor applications. This is a helpful method for studying the impedance resistance in electrochemical devices.

Electrochemical impedance spectroscopy (EIS) is a powerful technique to probe the kinetic processes and resistance characteristics of supercapacitor materials. In this study, the FRA impedance analysis of pure NiO, ZnO, and their composite ZnO/NiO was performed to understand their electrochemical behavior and potential for supercapacitor applications. FIG. 7 displays the EIS result, which was obtained in the 0.01 Hz-100 kHz frequency range.

Numerous investigations have demonstrated that supercapacitors' Nyquist charts have comparable forms. Solution resistance is demonstrated by the existence of Rₛ in the high-frequency region. It is possible to interpret the semicircle's lack of visibility as a decreased charge transfer resistance. Warburg resistance (Zw) is the name given to the low frequency slope of the curve that results from ion diffusion/transport in the electrolyte.

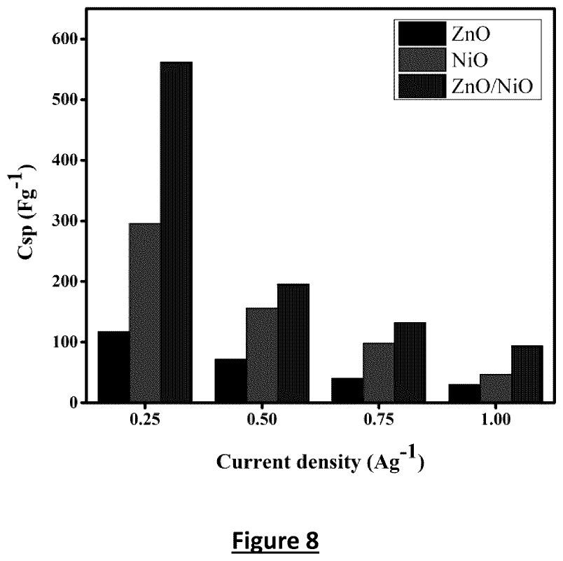

It is evident that the composite line of NiO and ZnO has a steeper slope. Compared to ZnO and NiO/ZnO composite, pure NiO has a higher semicircle. This shows that, in comparison to the NiO, the composite has a reduced Rs value (1.52Ω), Ret is 0.53Ω and high conductivity (FIG. 8, c). The high-frequency intercept on the real axis represents the solution resistance. The diameter of the semicircle in the high-to-mid frequency range corresponds to the charge transfer resistance. The low-frequency region indicates the Warburg impedance, which is related to ion diffusion/transport in the electrolyte.
1. Pure NiO:
   NiO displayed a higher semicircle diameter compared to ZnO and ZnO/NiO composite, indicating a higher charge transfer resistance.
   The R_s value for NiO was found to be higher (1.52Ω).
2. Pure ZnO:
   ZnO showed a comparatively lower charge transfer resistance than NiO.
   The Warburg impedance region for ZnO was less steep, indicating better ion diffusion properties.
3. ZnO/NiO Composite:
   The composite exhibited the steepest slope in the low-frequency region, indicating superior ion diffusion and transport characteristics.
   The R_s value for the composite was significantly lower (1.52Ω) compared to pure NiO, with an R_ct of 0.53Ω, demonstrating high conductivity.
   The Nyquist plot for the ZnO/NiO composite showed a much-reduced semicircle diameter, indicating lower charge transfer resistance and better electrochemical performance.

The impedance analysis highlights that the ZnO/NiO composite material possesses superior electrochemical properties compared to its individual components (pure NiO and ZnO). The reduced charge transfer resistance and enhanced ion diffusion capability suggest that the ZnO/NiO composite can provide higher specific capacitance and better energy storage performance. The synergistic effect between NiO and ZnO contributes to the enhancement in the electrochemical behavior of the composite material. The FRA impedance analysis reveals that the ZnO/NiO composite exhibits significantly improved electrochemical characteristics, making it a promising candidate for high-performance supercapacitor applications. The lower charge transfer resistance and superior ion diffusion properties of the composite material suggest its potential for efficient energy storage devices.

As a result, it is possible to significantly increase the capacitance of NiO, ZnO, and NiO/ZnO composite, making them more appropriate as electrode materials. The utilization of these results as outstanding-performance electrochemical pseudocapacitors also reveals an impressive cycling performance.

FIG. 8 illustrates Specific capacitance (Csp) of pure ZnO, NiO and ZnO/NiO composite Vs Current density (Ag⁻¹).

A p-n junction was formed when the p-type NiO was successfully built on the n-type ZnO matrix. A systemic investigation was conducted on the mechanism and capacitive performance. With a potential window of 0 to −1V, the constructed p-n heterojunction NiO/ZnO supercapacitor demonstrated exceptional capacitive capabilities, displaying a much higher specific capacity of 561.75 Fg⁻¹ at the current density of 0.25 A g⁻¹. The synergistic effects of the two metal oxides and the p-n heterojunction formed by the two phases of ZnO and NiO, which provide an abundance of active sites and charge transfer pathways for the diffusion of ions and electron transfer, respectively, are primarily responsible for these high supercapacitor performances.

These findings demonstrate that combination of two types of metal oxides enables the creation of energy-containing materials. The bar graph shows that Csp is retained 94Fg⁻¹ after 1Ag⁻¹ current density indicates the stability of the material. Therefore NiO/ZnO composite is more favorable for storage applications.

In an exemplary embodiment, the method is used for synthesizing a NiO/ZnO nanocomposite involves dissolving nickel nitrate and zinc nitrate in water with glucose and urea as fuel agents in stoichiometric ratios, followed by stirring the solution for uniform mixing and heating it in a muffle furnace at a temperature range of 440° C. to 460° C. to induce combustion, resulting in the formation of a porous NiO/ZnO nanocomposite. The resulting nanocomposite exhibits a porous structure with a high surface area, enhancing its electrochemical and catalytic performance by combining the pseudocapacitive behavior of NiO and the high electron mobility of ZnO. The NiO/ZnO nanocomposite is further utilized as an electrode material for supercapacitors by mixing it with carbon black and a binder to form a paste that is coated onto a nickel foam substrate, serving as the working electrode in a three-electrode system, where the supercapacitor demonstrates a specific capacitance of 561.75 F/g and retains 94% of its initial capacitance after 5000 cycles of charge/discharge. Additionally, the NiO/ZnO nanocomposite serves as a catalytic material for methane combustion, exhibiting enhanced catalytic activity due to oxygen vacancies in the ZnO structure and improved electron transfer from NiO, catalyzing methane combustion at a lower temperature compared to individual NiO and ZnO by following the Mars-van Krevelen mechanism for methane oxidation. The NiO/ZnO nanocomposite functions as a dual-purpose material for both high-performance supercapacitors as an electrode material and catalytic methane combustion owing to its enhanced redox activity and oxygen vacancy properties, with the optimal electrochemical and catalytic properties achieved by maintaining a Ni:Zn molar ratio of 1:1. The present invention conducts a comparative study of previously published works focusing on NiO, ZnO, and their nanocomposites for supercapacitor and catalytic applications. While individual NiO and ZnO nanostructures have been extensively studied for their electrochemical properties, limitations such as low conductivity (in the case of NiO) and low specific capacitance (in the case of ZnO) remain key challenges. Several recent studies have demonstrated that combining these oxides in a composite form significantly enhances their performance. The unique synergy between ZnO's high electron mobility and NiO's superior redox activity leads to improved specific capacitance, cycling stability, and catalytic performance. This invention builds on those findings, synthesizing NiO/ZnO nanocomposites using a solution combustion method, which results in highly porous structures that exhibit better electrochemical and catalytic properties compared to previously reported materials. The present work also addresses some of the gaps in the existing literature by demonstrating the dual functionality of the composites for both supercapacitor and methane combustion applications.

The NiO/ZnO nanoparticles were synthesized using the solution combustion synthesis method with glucose and urea as fuels. To achieve a constant molar concentration, 10 grams of Zn(NO₃)₂·6H₂O was dissolved in 30 ml of double-distilled water. Similarly, 10 grams of Ni(NO₃)₂·6H₂O was dissolved in 30 ml of double-distilled water. Stoichiometric amounts of urea, glucose, or a combination of both were added to this solution to serve as the fuel.

The ratio of oxidizers to fuel was equimolar, determined based on the oxidizing and reducing valencies of the compounds involved. The use of a fuel mixture was intended to enhance exothermicity and ensure complete reaction, as explained by the chemical reactions occurring during the process. The metal nitrates and fuels were dissolved using a magnetic stirrer for one hour until a homogeneous solution formed.

This homogeneous solution was then transferred to a Pyrex dish and placed in a preheated muffle furnace at 440-460° C. The solution initially boiled, then frothed, resulting in a fine powder. The combustion process was completed within 20 minutes, resulting in the formation of the NiO/ZnO nanocomposite.

Following synthesis, the obtained powder was allowed to cool naturally to room temperature. The cooled sample was then crushed and ground to achieve a fine, uniform consistency. The final product was stored in a dry and moisture-free environment to prevent contamination and maintain its structural integrity.

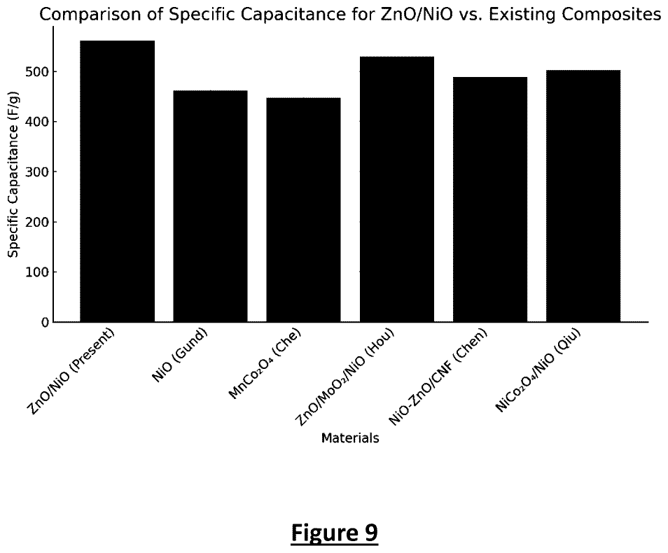

FIG. 9 illustrates a bar graph comparing specific capacitance.

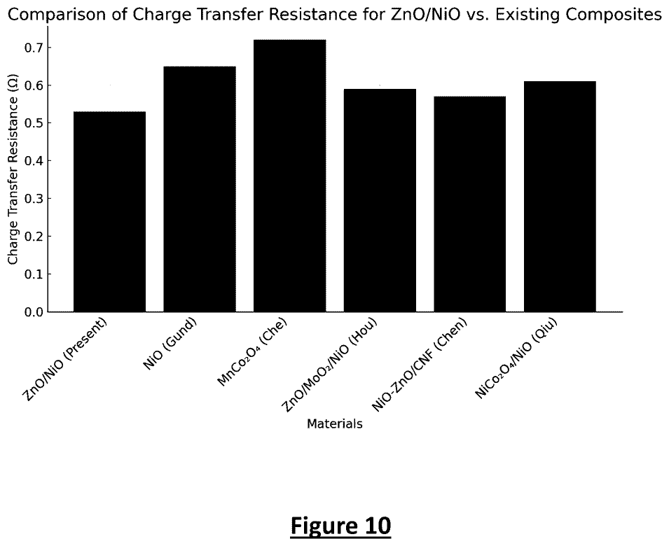

FIG. 10 illustrates a Nyquist plot comparing charge transfer resistance (R_ct).

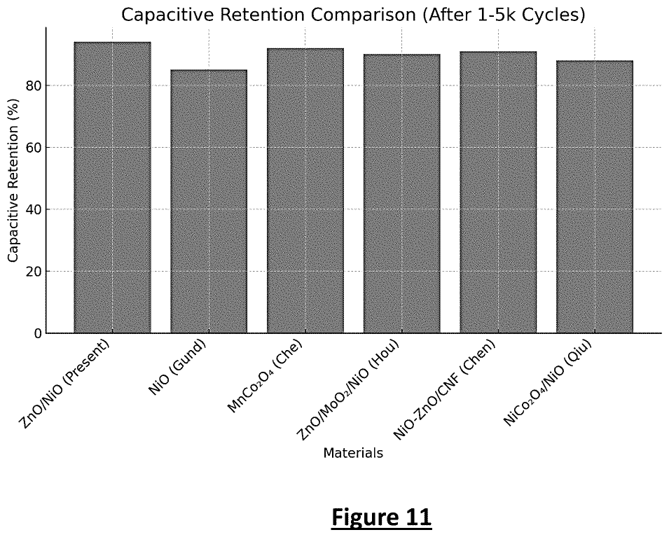

FIG. 11 illustrates capacitive retention over cycles.

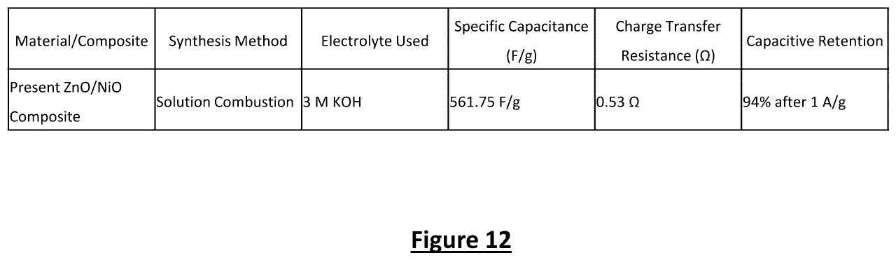

FIG. 12 illustrates a Table depicting key comparisons & observations.

The ZnO/NiO composite exhibits superior specific capacitance, achieving a remarkable value of 561.75 F/g, which significantly surpasses the capacitance values of individual NiO (295.5 F/g) and ZnO (117.3 F/g). This enhanced performance also exceeds many existing binary metal oxide composites such as MnCo₂O₄, NiO—ZnO/CNF, and NiCo₂O₄. Notably, its capacitance is comparable to ZnO/MoO₂/NiO (530 F/g) but slightly higher, attributed to enhanced synergistic effects between ZnO and NiO.

The ZnO/NiO composite also demonstrates the lowest charge transfer resistance (R_ct) of 0.53Ω, reflecting faster ion and electron transport. This value is significantly lower than pure NiO (1.52Ω), showcasing improved conductivity. The enhanced conductivity is credited to the formation of a p-n heterojunction, which facilitates smoother charge movement across the composite material.

In terms of stability and retention, the ZnO/NiO composite retains 94% of its capacitance at 1 A/g, indicating excellent cyclic stability. This retention rate is comparable to MnCo₂O₄ microstructures, which maintain 92% capacitance even after 2,000 cycles, reinforcing the composite's durability and long-term performance.

The superior electrochemical properties of the ZnO/NiO composite can be attributed to the presence of a p-n heterojunction formed between the p-type NiO and n-type ZnO. This junction improves electron mobility and charge transfer, significantly enhancing both capacitance and conductivity. This unique structural feature enables the ZnO/NiO composite to outperform other similar composites like NiO—ZnO/CNF and NiCo₂O₄/NiO, making it a highly efficient material for supercapacitor applications.

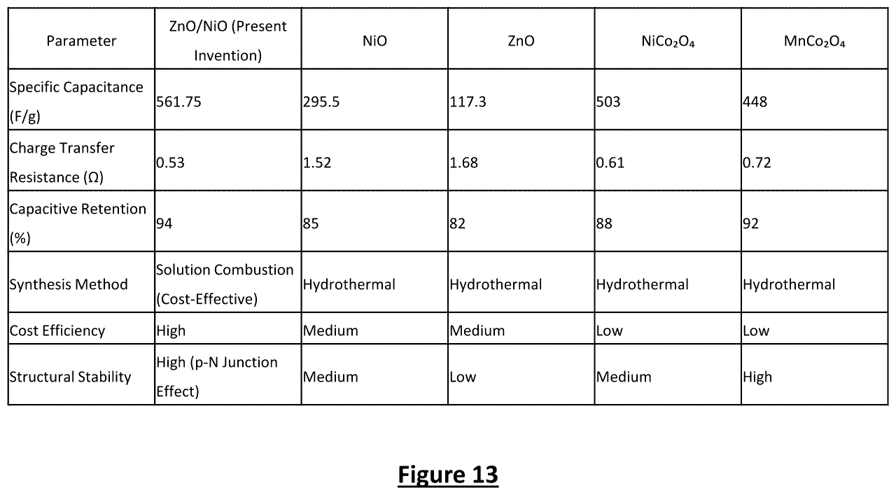

FIG. 13 illustrates a Table depicting a comparison with existing technology.

The ZnO/NiO nanocomposite synthesized using the solution combustion method demonstrates exceptional efficacy in electrochemical, structural, and catalytic performance metrics. This superior performance arises from the composite's synergistic effects, p-n heterojunction formation, enhanced charge transfer capabilities, and impressive cycling stability. These features collectively position the ZnO/NiO composite as a promising material for advanced supercapacitor applications.

One of the standout electrochemical characteristics of the ZnO/NiO nanocomposite is its high specific capacitance of 561.75 F/g, which far exceeds that of pure NiO (295.5 F/g) and ZnO (117.3 F/g). This impressive capacitance value also surpasses several contemporary supercapacitor materials. The enhanced capacitance is attributed to the p-n heterojunction formed between NiO and ZnO, which promotes efficient charge transfer. Additionally, the composite's higher surface area maximizes contact between the active material and electrolyte, facilitating improved ion diffusion and redox reaction efficiency.

The ZnO/NiO composite also boasts a remarkably low charge transfer resistance (R_ct) of 0.53Ω, ensuring faster electron transport. This value is significantly better than pure NiO (1.52Ω) and outperforms comparable materials like ZnO/MoO₂/NiO (0.59Ω) and NiCo₂O₄/NiO (0.61Ω). Lower resistance directly translates to faster charge/discharge cycles and higher power output. The formation of the p-n heterojunction further aids electron mobility, enhancing overall conductivity and electrochemical performance.

In terms of stability and cycling performance, the ZnO/NiO composite maintains 94% of its capacitance after extensive charge-discharge cycles, outperforming NiO—ZnO/CNF (91%) and NiCo₂O₄/NiO (88%). Its robust performance under high current densities ensures long-term durability for practical applications. The improved stability is credited to the porous nanosheet structure, which facilitates efficient ion transport, and the NiO—ZnO hybrid, which resists structural degradation better than single-phase metal oxides.

From a structural and morphological standpoint, the ZnO/NiO nanocomposite benefits from the synergistic interaction between NiO and ZnO. ZnO contributes high electrical conductivity, while NiO enhances pseudocapacitive behavior through faradaic redox reactions. Furthermore, oxygen vacancies in ZnO boost NiO's catalytic properties, enhancing charge storage capabilities. This combination results in superior electron mobility, increased reactive surface area, and enhanced redox reaction kinetics.

The formation of the p-n heterojunction plays a crucial role in improving the composite's electrochemical properties. The interaction between p-type NiO and n-type ZnO creates a junction that enhances electron movement across interfaces, boosting electrochemical activity and energy conversion efficiency. This structural feature ensures faster ion diffusion and improved redox kinetics, making the ZnO/NiO nanocomposite an ideal electrode material for supercapacitors.

The developed ZnO/NiO nanocomposite demonstrates an enhanced specific capacitance of 561.75 F/g, surpassing several existing metal oxide-based supercapacitor materials. This capacitance is significantly higher than that of pure NiO (295.5 F/g) and ZnO (117.3 F/g) alone. Moreover, it outperforms other advanced composites such as ZnO/MoO₂/NiO (530 F/g) and MnCo₂O₄ (448 F/g), establishing its superiority in energy storage applications.

The improved capacitance is attributed to the presence of more active redox sites, which result from the synergistic effect between NiO and ZnO. This synergy enhances charge storage capacity by promoting efficient electron mobility and redox reactions.

Conventional metal oxide materials typically exhibit capacitance values below 500 F/g. However, the ZnO/NiO composite achieves superior performance due to its unique combination of a p-n heterojunction, a porous nanostructure, and an optimized synthesis process. These factors collectively improve energy storage capabilities, making the ZnO/NiO composite a promising candidate for next-generation supercapacitor electrodes.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above about specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for synthesizing NiO/ZnO nanoparticles using solution combustion synthesis, comprising:
dissolving 10 grams of Zinc nitrate hexahydrate (Zn(NO₃)₂·6H₂O) and 10 grams of Nickel(II) nitrate hexahydrate (Ni(NO₃)₂·6H₂O) in 30 ml of double-distilled water to obtain a solution;
adding at least one fuel selected from a group consisting of glucose, urea, and combinations thereof to the solution, wherein a molar ratio of solution to fuel is equimolar based on their respective oxidizing and reducing valencies;
stirring the solution for one hour to achieve homogeneity and transferring the homogeneous solution into a Pyrex dish;
placing the dish inside a preheated muffle furnace at a temperature range of 440° C. to 460° C. and allowing the solution to boil, froth, and undergo exothermic combustion thereby retrieving the resulting fine nanoparticle powder upon completion of the reaction within 20 minutes; and
cooling the synthesized powder to room temperature and grinding the powder to achieve a fine, uniform consistency, thereby forming NiO/ZnO nanoparticles, and wherein the fuel is a combination of 50% of glucose and 50% of urea, and wherein said method further comprising annealing the synthesized nanocomposite at a temperature range of 500-600° C. to enhance crystallinity and electrochemical properties, wherein the annealing of the synthesized NiO/ZnO nanoparticle powder is performed under an inert argon atmosphere at a temperature of 550° C. for 3 hours, wherein the annealing temperature is increased at a ramp rate of 2° C. per minute to the target temperature to avoid particle sintering, and wherein the annealed powder is cooled to room temperature inside the closed furnace chamber to prevent thermal shock and moisture adsorption which may compromise the oxide phase integrity,
wherein the step of mixing 90% of an active material with 5% carbon black and 5% PVDF is preceded by dispersion of the active material in N-methyl-2-pyrrolidone (NMP) using ultrasonication for 15 minutes, wherein the ultrasonication is carried out at 60% amplitude using a probe sonicator to break apart agglomerated nanoparticles and uniformly suspend them, and wherein the subsequent mixing using a high-speed vortex mixer at approximately 600 rpm for 30 minutes results in a viscous, homogeneously distributed electrode slurry suitable for uniform deposition onto the nickel foam substrate; and
wherein the annealing temperature is selected based on preliminary thermogravimetric and differential scanning calorimetry analysis of the as-synthesized nanopowder, wherein the temperature corresponding to the complete crystallization and burnout of organic residues is identified from exothermic peaks in the thermal profile, and wherein this data is used to fix the optimal annealing temperature within the specified range of 500-600° C. to improve oxide phase purity and suppress undesired secondary phases.

2. The method of claim 1, further comprising:
mixing 90% of an active material selected from the group consisting of ZnO, NiO, and ZnO/NiO nanocomposite, with 5% of carbon black and 5% of polyvinylidene fluoride (PVDF) using a high-speed vortex mixer;
coating the mixture onto a nickel foam substrate; and
drying the coated nickel foam substrate under vacuum overnight at a temperature of approximately 50° C., wherein the high-speed vortex mixer operates at approximately 600 rpm, wherein the coated nickel foam substrate is dried for a duration of at least 8 hours, and wherein ZnO, NiO, and ZnO/NiO nanocomposite is preferably in mass proportions of 0.0106 g, 0.0109 g, and 0.0118 g, respectively.

3. The method of claim 1, wherein the step of dissolving 10 grams of Zinc nitrate hexahydrate and 10 grams of Nickel(II) nitrate hexahydrate in 30 ml of double-distilled water further comprises sequential addition of the Zinc nitrate hexahydrate followed by the Nickel(II) nitrate hexahydrate under continuous stirring, wherein the sequential addition promotes differential solvation kinetics between Zn²⁺ and Ni²⁺ ions, thereby reducing the risk of uncontrolled ionic aggregation, and wherein the complete dissolution is confirmed by achieving a visually clear and color-uniform solution before proceeding to the fuel addition step, and wherein the step of adding at least one fuel to the aqueous solution comprising the dissolved metal nitrates comprises preparing a premixed fuel blend of glucose and urea in a 1:1 molar ratio, wherein the fuel blend is pre-dissolved in a separate aliquot of double-distilled water at 60° C. to ensure complete disintegration of carbohydrate crystals and homogeneous molecular dispersion, and wherein the fuel solution is added dropwise to the nitrate solution under constant magnetic stirring to prevent local hot spots and to facilitate molecular-level mixing of oxidizing and reducing species.

4. The method of claim 1, wherein the stirring step is conducted using a magnetic stirrer operating at a speed between 200-500 rpm, and wherein the magnetic stirring of the combined nitrate-fuel solution at 200-500 rpm for one hour is carried out at a controlled solution temperature between 50° C. and 60° C., wherein the temperature is maintained using a thermostatically controlled hotplate to enhance solvation dynamics without initiating premature thermal decomposition, and wherein the pH of the mixture during stirring is monitored and adjusted to remain between 6.0 and 7.0 using dilute nitric acid to ensure metal ion stability and suppression of undesired hydrolytic precipitation prior to combustion.

5. The method of claim 1, wherein the step of placing the homogeneous solution into the muffle furnace at a temperature range of 440° C. to 460° C. further comprises holding the solution undisturbed during combustion for a duration not exceeding 20 minutes, wherein the combustion proceeds through observable phases including initial solvent evaporation, frothing due to gas evolution, onset of ignition, and spontaneous flame propagation, and wherein the transition from frothing to ignition occurs within 6 to 8 minutes from furnace insertion, indicating sufficient accumulation of reactive intermediates for self-sustaining combustion without external flame initiation.

6. The method of claim 1, wherein the combustion step further comprises real-time monitoring of the reaction vessel through a quartz observation port in the furnace, wherein visible light emissions corresponding to distinct combustion phases are used to identify ignition onset and flame front progression, and wherein the self-sustaining reaction is allowed to proceed without external intervention to completion, as indicated by cessation of luminescence and the emergence of a solid foamy residue with distinct color transition from brown to light grey, and wherein after combustion and before grinding, the intermediate foamy powder is subjected to gentle crushing using a non-metallic spatula under a fume hood, wherein the goal is to break down fragile macrostructures without generating static charges or introducing metallic contamination, and wherein the intermediate material is then transferred to an agate mortar for manual grinding until a particle size distribution below 100 microns is visually confirmed via sieving, and wherein the final ground powder is washed with ethanol and deionized water in a 1:1 ratio and dried at 80° C. for 4 hours in a vacuum oven, wherein this washing step is intended to remove residual carbonaceous by-products or unreacted organic fuel remnants, and wherein the success of washing is confirmed by observing the disappearance of C-H stretching bands in the FTIR spectrum of the dried powder.

7. The method of claim 2, wherein the mixture comprising 90% of ZnO/NiO nanocomposite, 5% carbon black, and 5% PVDF is prepared by first dissolving PVDF in NMP at 80° C. under magnetic stirring for 1 hour to form a uniform polymer solution, wherein the active material and carbon black are incrementally added to the polymer solution under vortex agitation to prevent phase separation, and wherein the final slurry viscosity is maintained between 500-700 cP to enable consistent electrode coating thickness on the nickel foam substrate, and wherein after coating the slurry onto the nickel foam substrate, the coated substrate is allowed to air-dry for 2 hours before vacuum drying at approximately 50° C., wherein this two-stage drying facilitates slow solvent evaporation to prevent crack formation in the electrode film, and wherein the vacuum drying is conducted in a humidity-controlled chamber (RH<10%) to avoid moisture absorption by the polymer binder, thereby preserving interparticle adhesion.

8. The method of claim 1, wherein prior to the addition of the fuel, a chelating agent selected from the group consisting of citric acid, ethylenediamine, or nitrilotriacetic acid is added to the aqueous solution containing the dissolved Zinc nitrate hexahydrate and Nickel(II) nitrate hexahydrate, wherein the chelating agent is added in a molar ratio of 1:1 with the total metal ion concentration to form stable metal-ligand complexes, and wherein this chelation step delays premature hydrolysis of metal ions and enables controlled combustion by altering the decomposition pathway of the metal precursors.

9. The method of claim 1, wherein after the stirring step and prior to the combustion step, the homogeneous precursor solution is subjected to a controlled pre-decomposition treatment in a nitrogen-purged chamber at 150° C. for 30 minutes, wherein this step induces partial evaporation of volatile organics and results in the formation of a gel-like mass that exhibits enhanced exothermicity during subsequent high-temperature combustion, and wherein the pre-decomposed material leads to finer particle morphology and reduced agglomeration in the final nanopowder, and wherein the glucose and/or urea fuel is chemically modified prior to addition by reacting it with phosphoric acid to form a phosphorylated intermediate fuel complex, wherein this functionalization introduces additional oxygen-containing species that participate in the redox balance of the combustion process, and wherein the phosphorylated fuel leads to enhanced combustion enthalpy and formation of doped oxide species with higher surface area and defect density.

10. The method of claim 1, wherein prior to the combustion step, the homogeneous solution is irradiated using microwave energy at a frequency of 2.45 GHz for 5 minutes at 300 W, wherein this microwave-assisted pre-treatment initiates mild crosslinking between metal-ligand complexes and the fuel molecules, and wherein this pre-conditioning reduces the activation energy required for spontaneous combustion, thereby enhancing particle uniformity and phase purity, and wherein the combustion reaction is carried out under real-time thermal imaging using an infrared (IR) camera capable of detecting temperature variations across the reaction surface, wherein thermal gradients are analyzed during combustion to detect premature quenching or non-uniform ignition zones, and wherein adaptive thermal control is employed to maintain a stable reaction temperature range of 445° C. to 455° C. through dynamic feedback control of the muffle furnace power input.

11. The method of claim 1, wherein after grinding the powder, the material is subjected to post-synthesis acid etching using 0.1 M hydrochloric acid solution for 10 minutes under magnetic stirring, wherein the acid selectively removes surface-bound unreacted metallic species or secondary phases, and wherein the etched product is subsequently washed with ethanol and dried under vacuum to yield a high-purity NiO/ZnO nanocomposite with exposed surface active sites, and wherein prior to fuel addition, a redox potential tuning step is introduced by bubbling a reducing gas such as hydrogen or forming gas through the nitrate solution for 10 minutes, wherein this step reduces a fraction of Ni²⁺ ions to Ni⁺ in situ without precipitating metallic nickel, thereby altering the redox dynamics during combustion, and wherein this redox-modified solution produces nanoparticles with altered electronic properties and enhanced charge storage capacity.

12. The method of claim 1, wherein an organosilane compound selected from the group consisting of tetraethyl orthosilicate (TEOS), methyltrimethoxysilane (MTMS), or aminopropyltriethoxysilane (APTES) is added in a concentration of 0.5-1.0 wt % to the aqueous metal nitrate solution prior to the fuel addition step, wherein the organosilane undergoes partial hydrolysis and condenses during the combustion process to form silica nanodomains, and wherein the resulting NiO/ZnO nanoparticles exhibit enhanced dispersion stability and reduced particle-particle agglomeration due to in situ siloxane passivation.

13. The method of claim 1, wherein an ionic liquid selected from the group consisting of 1-butyl-3-methylimidazolium tetrafluoroborate, 1-ethyl-3-methylimidazolium acetate, or choline chloride-urea deep eutectic solvent is used as a partial replacement (10-30 vol %) for the aqueous solvent during metal nitrate dissolution, wherein the ionic liquid acts as both a solvothermal modifier and structural directing agent during combustion, and wherein the ionic liquid-assisted route leads to tailored nanostructures with anisotropic growth patterns and controlled aspect ratios.

14. The method of claim 1, wherein a halide salt selected from the group consisting of potassium iodide, lithium chloride, or ammonium fluoride is introduced at trace concentrations (<0.5 mol %) into the precursor solution, wherein the halide species transiently coordinate with Zn²⁺ and Ni²⁺ ions to disrupt lattice symmetry during combustion, and wherein post-synthesis annealing volatilizes the halide residues, leaving behind lattice strain-induced oxygen vacancies that enhance electrochemical reactivity.

15. The method of claim 1, wherein the nitrate solution is supplemented with a redox mediator compound selected from the group consisting of 1,4-benzoquinone, potassium ferrocyanide, or sodium thiosulfate prior to the addition of the fuel, wherein the redox mediator modulates the combustion front propagation velocity by buffering electron transfer steps between oxidant and fuel molecules, and wherein the use of such mediator yields more uniform thermal gradients during combustion and results in narrower nanoparticle size distributions.

16. The method of claim 1, wherein a metal-organic framework (MOF) precursor selected from the group consisting of ZIF-8, Ni-BDC, or Zn-Triazole complexes is added as a solid templating agent in the amount of 3-10 wt % prior to the combustion step, wherein the MOF thermally decomposes in situ to provide a porous scaffold and release coordinated metal ions that integrate into the NiO/ZnO lattice, and wherein the resulting composite exhibits hierarchical porosity and increased electrochemical active surface area.

17. The method of claim 1, wherein a volatile organic acid selected from the group consisting of formic acid, propionic acid, or trifluoroacetic acid is added to the metal nitrate solution in a molar ratio of 0.2-0.5 relative to total metal ions, wherein the acid functions as both a complexing agent and a combustion modifier that lowers ignition delay by generating reactive intermediate metal-carboxylate complexes, and wherein the evolved gas species during combustion include formate or fluoroform by-products that aid pore formation and nano-scaling of the oxide product.

18. The method of claim 1, wherein after the homogeneous solution is prepared, a pulsed electric field (PEF) treatment is applied using electrodes immersed in the solution, wherein pulsed voltages in the range of 500-1000 V/cm are applied at a frequency of 1-5 Hz for a duration of 2-3 minutes, and wherein this treatment induces transient electrophoretic migration of ionic species to enhance precursor homogenization, pre-nucleation structure ordering, and ultimately yields smaller, more uniform nanoparticles post combustion, wherein a photosensitive compound selected from the group consisting of azobenzene derivatives, spiropyran, or diazonium salts is added in a concentration of 0.1-0.3 wt % to the precursor mixture, wherein the solution is irradiated with UV light at 365 nm for 5 minutes prior to combustion to activate molecular conformation changes in the additive, and wherein the activated state contributes additional thermal energy release upon combustion initiation, resulting in localized microburst combustion zones and fractal-like surface morphologies in the synthesized nanoparticles.

19. The method of claim 1, wherein a transition metal complex selected from the group consisting of nickel acetylacetonate, zinc citrate, or bis(ethylenediamine)nickel(II) chloride is added alongside the corresponding metal nitrate salts in a ratio of 1:4 (complex to nitrate), wherein the mixed precursor system alters the combustion dynamics by introducing ligated metal coordination spheres that decompose at staggered thermal thresholds, and wherein the controlled decomposition contributes to bimodal nanoparticle size distribution and multi-domain crystallinity in the final NiO/ZnO product, and wherein after the combustion synthesis and grinding steps, the nanopowder is subjected to a staged atmosphere-switching heat treatment, wherein the powder is first held at 300° C. in a flowing hydrogen-nitrogen gas mixture for 30 minutes, followed by re-oxidation at 400° C. in air for 1 hour, and wherein this dual-atmosphere cycling induces defect-engineered oxygen vacancies and reorients surface terminations of NiO and ZnO phases, thereby improving electronic conductivity and surface redox activity.
